(19) United States
(12) Patent Application Publication
(10) Pub. No.: US 2026/0339135 A1
(43) Pub. Date: Oct. 29, 2026

(54) SYSTEM AND METHOD FOR PRESERVING PRIVACY VIA CONTROL OF IMAGE VIEWING ANGLES FROM A DIGITAL DISPLAY DEVICE WITH AN OPTICALLY TRANSPARENT METAL-INSULATOR-TRANSITION BASED METASURFACE

(71) Applicant: Dell Products LP, Round Rock, TX (US)

(72) Inventors: Tejinder Singh, Manotick (CA); Navjot Kaur Khaira, Manotick (CA); Harpreet S. Narula, Austin, TX (US)

(73) Assignee: Dell Products LP, Round Rock, TX (US)

(21) Appl. No.: 19/193,522

(22) Filed: Apr. 29, 2025

(51) Int. Cl. G02F 1/13; G01S 17/04; G02F 1/00; G06F 21/84

(52) U.S. Cl. CPC G02F 1/132; G01S 17/04; G02F 1/009; G06F 21/84; G02F 2202/30

(57) ABSTRACT

A system and method includes a metal-insulator-transition (MIT)-based metasurface privacy layer formed over a digital display panel of a digital display device comprising a first thermoelectric element layer and a second thermoelectric element layer each having a plurality of thermoelectric material rods, an MIT layer to transition from a transparent state to a metallic opaque state along the thermoelectric material rods with heating, and a transparent nano-patch grating and diffraction layer that diffracts images. A human presence detection sensor detects a human eavesdropper and a metasurface hardware controller executing machine readable code instructions of a human presence convolutional neural network algorithm identifies a position of the human eavesdropper to identify which of the plurality of thermoelectric material rods in the first thermoelectric element layer or the second thermoelectric element layer to activate heating at the MIT layer to dynamically reduce a viewing angle of images from the digital display panel.

### FIELD OF THE DISCLOSURE

The present disclosure generally relates to a metasurface system and device for creating dynamically changing viewing angles at digital display devices of information handling systems. The present disclosure more specifically relates to a system and method for preserving privacy of viewing angles for images displayed from a digital display device using an optically transparent metal-insulator-transition (MIT) based metasurface made of an MIT layer with adjustable light opacity portions changing light through a nano-patch grating and diffraction layer.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, and video communication capabilities that may include wireless communications. The information handling system may be used to operate a wireless interface adapter and radio system for transmission of radio signals to a target receiving wireless device or access point device or to receive radio signals from the target wireless device or access point device. The information handling system may be used to operate a digital display device with a hardware processing resource for displaying digital media generated from execution of software applications for interaction with a user.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system comprising a digital display device that implements human presence detection sensor and a metal-insulation-transition (MIT) based metasurface privacy layer that includes an adjustable MIT material layer with adjustable opacity and a nano-patch grating and diffraction layer according to an embodiment of the present disclosure;

FIG. 2 is a block diagram illustrating an information handling system comprising a digital display device including a display panel that implements an MIT-based metasurface privacy layer that includes an MIT layer of adjustable opacity material with selective application of thermoelectric heating elements according to another embodiment of the present disclosure;

FIG. 3 is an exploded perspective view diagram showing an MIT-based metasurface privacy layer including an adjustable MIT layer with adjustable opacity from thermoelectric heating elements and a nano-patch grating and diffraction layer of a digital display device according to an embodiment of the present disclosure;

FIG. 4 is a side exploded view diagram showing an information handling system that includes an adjustable MIT layer with adjustable opacity from thermoelectric heating elements and a nano-patch grating and diffraction layer to adjust a width of an image field of view according to an embodiment of the present disclosure; and

FIG. 5 is a flow diagram of a method of preserving privacy of image viewing at a digital display device using an MIT-based metasurface privacy layer that includes an adjustable MIT layer and a nano-patch grating and diffraction layer based on human presence detection sensor readings according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

Privacy in public areas has become a growing demand for users of information handling systems such as laptops or tablets. This is especially true when these laptop-type information handling systems or other information handling systems with digital display devices can be carried to or used in public locations allowing the user to work where others can see the digital display device of the information handling system. Some technologies have been developed to prevent human eavesdroppers from viewing, at least at certain angles, the user's digital display device. Some of these technologies include masks, tints, diffraction gradings, or other films that can be applied to the surface of the user's digital display device that prevent those images displayed on the digital display device to be viewed from different viewing angles. However, these masks, tints, diffraction gradings, or other films can prove difficult to use and may reduce the brightness of the user's screen thereby interfering with the user's ability to interact with the information handling system. Furthermore, most require manual implementation.

Thus, the present specification describes an information handling system that includes a hardware processor, a memory device, and a power management unit (PMU) to provide power to the hardware processor and memory device. The information handling system of embodiments of the present disclosure may also include a digital display device comprising a MIT-based metasurface privacy layer. This MIT-based metasurface privacy layer includes, at least, a first thermoelectric element layer, a second thermoelectric element layer, a metal-insulator-transition (MIT) layer with adjustable opacity with heating, and a nano-patch grating and diffraction layer that is transparent but diffracts light from images displayed on the digital display device in embodiments herein. The information handling system also includes a human presence detection sensor to detect the presence of human eavesdropper near the digital display device in an embodiment. During operation, the hardware processor of an information handling system or a metasurface hardware controller receives data from the human presence detection sensor, and based on that range or angle location detected for an eavesdropper, and executes machine readable code instructions to select a voltage to be applied to at least one heating line thermoelectric element of the first thermoelectric element layer or second thermoelectric element layer. This at least one heating line thermoelectric element of the first thermoelectric element layer or second thermoelectric element layer with voltage applied heats a strip or portion of the MIT layer to transition that corresponding strip of the MIT layer from a transparent state to an opaque state or one of a plurality of semi-opaque states.

In an embodiment, the first thermoelectric element layer and the second thermoelectric element layer includes a plurality of rods of lossy indium tin oxide (ITO) that is transparent to light. These plurality of rods of ITO may be individually heated as the heating line thermoelectric elements such that the MIT layer may be heated across various strips corresponding to those heating line thermoelectric elements. These various strip portions of the heated MIT layer transitions from an insulative and transparent state to a metallic and opaque state. By doing so, only specific linear strip portions that have been heated on the MIT layer become opaque. As light passes through the MIT layer, which is thin enough to be transparent in a non-heated state, it is refracted by the nano-patch grating and diffraction layer. When this light is interrupted by one or more linear strip portions that have been heated on the MIT layer become opaque, the refraction index of the nano-patch grating and diffraction layer blurs light along sides of the corresponding opaque linear strip portions while direct, central light passes through the nano-patch grating and diffraction layer providing a reduced-width viewing angle of the images from the display panel. The MIT-based metasurface privacy layer with activated and heated opaque linear strip portions alters high-angle incident light being reflected or refracted through the nano-patch grating and diffraction layer on the side of those opaque linear strip portions blurring the viewable image angles from the display panel instead of passing light through the MIT layer. By increasing the number of plurality of rods of lossy ITO of the first thermoelectric element layer or the second thermoelectric element layer from a left, right, top or bottom side of the display panel that are heated, that width of the field of view of images from the display panel may be narrowed relative to that left, right, top or bottom side thus limiting the angle at which the display panel screen can be viewed. The nano-patch grating and diffraction layer with its nano-patches may be designed to manipulate the phase and direction of the light such that, for light at oblique angles, the grating causes diffraction and scattering thereby effectively redirecting or cancelling those light rays interrupted by the opaque linear strip portions of the MIT layer to blur, darken, or reduce angles of viewability of light for the image on the side activated. Thus, this grating angular response may be tailored with selected activation of a vertical or horizontal grid of heating line thermoelectric elements in the first thermoelectric element layer or the second thermoelectric element layer respectively to allow light of viewable images only within a target viewing angle range field of view depending on the number of heating line thermoelectric elements activated.

In an embodiment, the viewing angle for viewable images may be tailored to accommodate for the presence of human eavesdroppers at specific angles relative to the digital display device and eliminate viewability for those human eavesdroppers. In another embodiment, the viewing angle for viewable images may be tailored to accommodate an identified authorized user at specific angles relative to the digital display device and adjust viewability of the viewing angle for that identified authorized user, such as when she or he moves in front of the digital display device. In embodiments of the present disclosure, the information handling system or digital display device may include a human presence detection sensor. This human presence detection sensor may be any type of human presence detector such as a light detection and ranging (LiDAR) sensor that may detect range and angles of a user and other eavesdropper humans. This metasurface hardware controller or the hardware processor at an information handling system receives output from the human presence detection sensor and determine the position and movement of an identified user and a potential human eavesdropper who would be capable of seeing the user's screen. This allows the hardware processor or metasurface hardware controller to execute computer-readable program code of a human presence convolutional neural network (CNN) algorithm.

The hardware processor or metasurface hardware controller may receive the range and angles of users or potential human eavesdroppers the human presence detection sensor as input into the human presence CNN algorithm. The hardware processor or metasurface hardware controller executes machine readable code instructions of the human presence CNN algorithm to identify an authorized user as well as human presence of any eavesdropper humans in front of the digital display device. With this range and angle data as well as identification of the authorized user and any eavesdropper humans present, the hardware processor or metasurface controller executing the human presence CNN algorithm determines how to apply a voltage to at least one the plurality of heating line thermoelectric element (e.g., lossy ITO rods) of the one or both of the first thermoelectric element layer and second thermoelectric element layer. Heating one or more heating line thermoelectric element decreases a viewing angle of images from the digital display device by transitioning opaque strips of the MIT layer of the MIT-based metasurface privacy layer to affect refraction through the nano-patch grating and diffraction layer reducing the width of the viewing angle on at least one side or along plural left, right, top, or bottom sides. This data may be sent to a metasurface hardware microcontroller to, with the metasurface PMU, selectively apply a voltage to those identified one or more heating line thermoelectric elements, such as lossy ITO rods, in order to heat the MIT layer so as to obfuscate at least a portion of the digital display device at wider viewing angles to those identified human eavesdroppers.

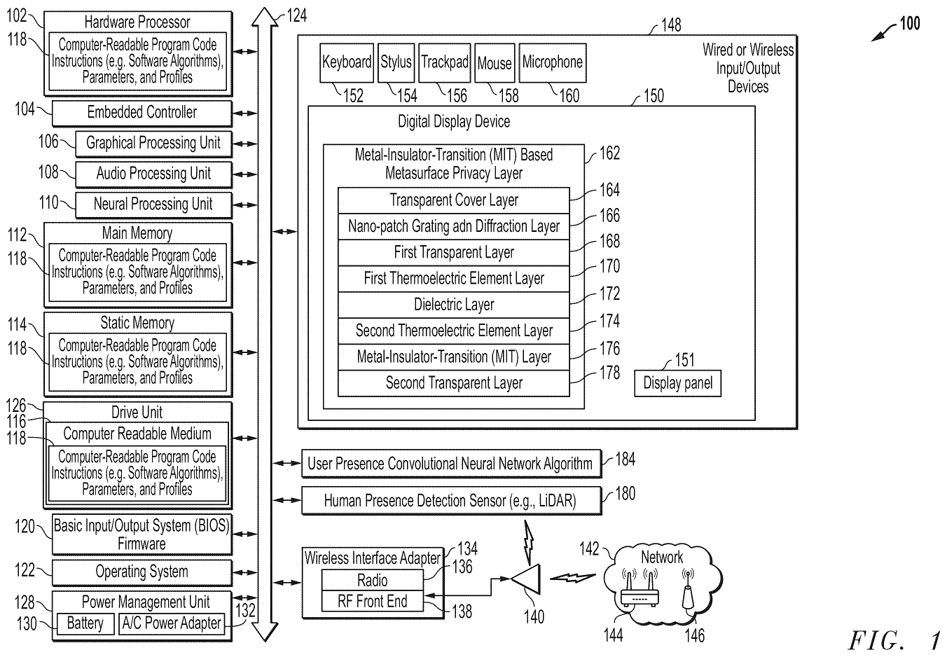

Turning now to the figures, FIG. 1 illustrates an information handling system 100 similar to the information handling systems according to several aspects of the present disclosure. In the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 may be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a communications device, an access point (AP) 144, a base station transceiver 146, a wireless telephone, a control system, a camera, a scanner, a printer, a personal trusted device, a web appliance, or any other suitable machine capable of executing a set of instructions (sequential or otherwise) that specify actions to be taken by that machine, and may vary in size, shape, performance, price, and functionality.

In a networked deployment, the information handling system 100 may operate in the capacity of a client computer in a server-client network environment, or as a peer computer system within a peer-to-peer (or distributed) network environment. In an embodiment, the information handling system 100 may be implemented using electronic devices that provide voice, video, or data communication. For example, an information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute a set, or plural sets, of instructions to perform one or more computer functions.

The information handling system 100 may include main memory 112, (volatile (e.g., random-access memory, etc.), or static memory 114, nonvolatile (read-only memory, flash memory etc.) or any combination thereof), one or more hardware processing resources, such as a hardware processor 102 that may be a central processing unit (CPU), embedded controller (EC) 104, a graphics processing unit (GPU) 106, a neural processing unit (NPU) 110, an accelerated processing unit (APU) 108, other types of hardware processing devices, or any combination thereof. It is appreciated that the information handling system 100 may include any number of hardware processing devices described herein. Computer readable code instructions stored in main memory 112 (e.g., RAM) may be accessible by hardware processing resources using that main memory 112. Machine readable code instructions stored in static memory 114, main memory 112, or drive unit 126 may be involved in invoking such machine readable code instructions to main memory 112 according to embodiments herein. Additional components of the information handling system 100 may include one or more storage devices such as static memory 114 or drive unit 126. The information handling system 100 may include or interface with one or more communications ports for communicating with external devices, as well as various wired or wireless input and output (I/O) devices 148, such as a mouse 158, a trackpad 156, a stylus 154, a keyboard 152, a digital display device 150, a microphone 160, or any combination thereof. Portions of an information handling system 100 may themselves be considered information handling systems 100.

Information handling system 100 may include devices or modules that embody one or more of the devices or execute instructions for one or more systems and modules. The information handling system 100 may execute machine readable code instructions (e.g., software algorithms) parameters, and profiles 118 that may operate on servers or systems, remote data centers, or on-box in individual client information handling systems according to various embodiments herein. In some embodiments, it is understood any or all portions of machine readable code instructions (e.g., software algorithms) parameters, and profiles 118 may operate on a plurality of information handling systems 100.

The information handling system 100 may include the hardware processor 102 such as a central processing unit (CPU) or other hardware processing resource (e.g., 104, 106, 108, 110). Any of the hardware processing resources may operate to execute computer readable code instructions that are either firmware or software code, such as those software systems and modules described herein. Moreover, the information handling system 100 may include memory such as main memory 112, static memory 114, and disk drive unit 126 (volatile (e.g., random-access memory, etc.), nonvolatile memory (read-only memory, flash memory etc.) or any combination thereof or other memory with computer readable medium 116 storing machine readable code instructions (e.g., software algorithms) parameters, and profiles 118 executable by the hardware processor 102 (e.g., central processing unit), NPU 110, APU 108, EC 104, GPU 106, or any other hardware processing device. The information handling system 100 may also include one or more buses 124 operable to transmit communications between the various hardware components such as any combination of various wired or wireless I/O devices 148 as well as between hardware processors 102, an EC 104, the operating system (OS) 122, the basic input/output system (BIOS) 120, the wireless interface adapter 134, or a radio module, among other components described herein. In an embodiment, the hardware processor 102, EC 104, GPU 106, NPU 110, APU 108, and/or others may execute one or more bus drivers in order to transmit this data between the information handling system 100 and the wired or wireless input/output devices 148 described herein. In an embodiment, the information handling system 100 may be in wired or wireless communication with the wired or wireless I/O devices 148 such as a keyboard 152, a mouse 158, digital display device 150, stylus 154, trackpad 156, microphone 160, among other peripheral devices.

As described herein, the information handling system 100 further includes a digital display device 150. The digital display device 150 in an embodiment may function as a liquid crystal display (LCD), an organic light emitting diode (OLED), a flat panel display, or a solid-state display. In embodiments herein, the digital display device 150 includes a display panel 151 that is responsible for emitting light therefrom in order to create the images, text, and other information on the surface of the digital display device as output to the user. It is appreciated that the digital display device 150 may be wired or wireless and may be an external digital display device 150 that allows a user to increase the desktop area by extending the desktop in an embodiment. Additionally, as described herein, the information handling system 100 may include or be operatively coupled to a cursor control device (e.g., a trackpad 156, or gesture or touch screen input), a stylus 154, and/or a keyboard 152, among others that allows the user to interface with the information handling system 100 via the digital display device 150. Information handling system 100 may also be operatively coupled to a wired or wireless input/output device 148 or other hardware devices that may include a hardware processing device such as a hardware processor, microcontroller, or other hardware processing resource. Various drivers and hardware control device electronics may be operatively coupled to operate the wired or wireless I/O devices 148 according to the embodiments described herein. The present specification contemplates that the wired or wireless I/O devices 148 may be wired or wireless.

A network interface device of the information handling system 100 may be wired or wireless such as shown with wireless interface adapter 134 that can provide wireless connectivity among plural devices such as with Bluetooth® or to a network 142 such as with a wide area network (WAN), a local area network (LAN), wireless local area network (WLAN), a wireless personal area network (WPAN), a wireless wide area network (WWAN), or other network. In embodiments described herein, the wireless interface device 134 with its radio 136, RF front end 138 and antenna 140 is used to communicate with the wireless peripheral devices, via, for example, a Bluetooth® or Bluetooth® Low Energy (BLE) protocols or any proprietary RF protocol such as those may utilize similar frequency ranges but proprietary modulation and data transmission characteristics. In embodiments, Bluetooth®, BLE, proprietary RF protocol, or other WPAN or WLAN protocols and plural such protocols may be used for communication with and among any wireless peripheral device to be paired or paired with the information handling system 100 or other information handling systems.

In other embodiments, the wireless interface device 134 with its radio 136, RF front end 138 and antenna 140 is used to communicate with a WWAN or and WLAN which may each include an AP 144 or base station 146 used to operatively couple the information handling system 100 to a network 142 via the wireless interface adapter 134. In a specific embodiment, the network 142 may include macro-cellular connections via one or more base stations 146 or a wireless AP 144 (e.g., Wi-Fi), or such as through licensed or unlicensed WWAN small cell base stations 146. Connectivity may be via wired or wireless connection. For example, wireless network wireless APs 144 or base stations 146 may be operatively connected to the information handling system 100. Wireless interface adapter 134 may include one or more RF (RF) subsystems (e.g., radio 136) with transmitter/receiver circuitry, modem circuitry, one or more antenna RF (RF) front end 138 circuits, one or more wireless controller circuits, amplifiers, antennas 140 and other circuitry of the radio 136 such as one or more antenna ports used for wireless communications via multiple radio access technologies (RATs). The radio 136 may communicate with one or more wireless technology protocols. The receiver device may be any other device and may include the AP 144, the base station 146, or any other computing device described herein. Additionally, the information handling system 100 and receiver device may be capable of transmitting wireless data using, for example, EM waves that include 5G mm wave lengths such as those included within the 20-50 GHz range or WiFi wavelengths such as 2.4 GHz, 5 GHz, 6 GHz or others to be used with later versions of WiFi.

In an embodiment, the wireless interface adapter 134 may operate in accordance with any wireless data communication standards. To communicate with a wireless local area network and/or the receiver device, standards including IEEE 802.11 WLAN standards (e.g., IEEE 802.11ax-2021 (Wi-Fi 6E, 6 GHz)), IEEE 802.15 WPAN standards, WWAN such as 3GPP or 3GPP2, Bluetooth® standards, proprietary RF protocol, or similar wireless standards may be used. Wireless interface adapter 134 may connect to any combination of macro-cellular wireless connections including 2G, 2.5G, 3G, 4G, 5G or the like from one or more service providers. Utilization of RF communication bands according to several example embodiments of the present disclosure may include bands used with the WLAN standards and WWAN carriers which may operate in both licensed and unlicensed spectrums. The wireless interface adapter 134 can represent an add-in card, wireless network interface module that is integrated with a main board of the information handling system 100 or integrated with another wireless network interface capability, or any combination thereof. Via wireless communications from wireless adapter 134 under any particular WLAN or WAN wireless protocols, information handling system 100 may operate as a transmitting or receiving wireless device of RF signals across a wireless network 142 in a radiofrequency environment according to embodiments of the present disclosure.

In some embodiments, a hardware processing resource executes machine readable code instructions of software or firmware to implement one or more of some systems and methods described herein, or dedicated hardware implementations such as application specific integrated circuits, programmable logic arrays and other hardware devices may be constructed to implement one or more of some systems and methods described herein. Applications that may include the apparatus and systems of various embodiments may broadly include a variety of electronic and computer systems. One or more embodiments described herein may implement functions using two or more specific interconnected hardware devices with related control and data signals that may be communicated between and through the modules, or as portions of an application-specific integrated circuit (ASIC). Accordingly, the present system encompasses a hardware processing resource executing machine readable code instructions of software or firmware as well as hardware implementations or any combination.

In accordance with various embodiments of the present disclosure, the methods described herein may be implemented by firmware or software programs executable by a hardware controller or a hardware processor system. Further, in an exemplary, non-limited embodiment, implementations may include distributed hardware processing, component/object distributed hardware processing, and parallel hardware processing. Alternatively, virtual computer system processing may be constructed to implement one or more of the methods or functionalities as described herein.

The present disclosure contemplates a computer-readable medium that includes machine readable code instructions, parameters, and profiles 118 or receives and executes machine readable code instructions, parameters, and profiles 118 responsive to a propagated signal, so that a hardware device connected to a network 142 may communicate voice, video, or data over the network 142. Further, the machine readable code instructions, parameters, and profiles 118 may be transmitted or received over the network 142 via the network interface device or wireless interface adapter 134.

The information handling system 100 may include a set of machine readable code instructions, parameters, and profiles 118 that may be executed to cause the computer system to perform any one or more of the methods or computer-based functions disclosed herein. For example, machine readable code instructions, parameters, and profiles 118 may be executed by a hardware processor 102, GPU 106, EC 104, APU 108, NPU 110, or any other hardware processing resource and may include software agents, or other aspects or components used to execute the methods and systems described herein. Various software modules comprising application machine readable code instructions, parameters, and profiles 118 may be coordinated by an operating system (OS) 122, and/or via an application programming interface (API) include a unified device API described herein. An example OS 122 may include Windows®, Android®, and other OS types. Example APIs may include Win 32, Core Java API, or Android APIs.

In an embodiment, the information handling system 100 may include a disk drive unit 126. The disk drive unit 126 and may include machine-readable program code instructions, parameters, and profiles 118 in which one or more sets of machine-readable program code instructions, parameters, and profiles 118 such as firmware or software can be embedded to be executed by the hardware processor 102 (e.g., CPU) or other hardware processing devices such as a GPU 106, an EC 104, an NPU 110, an APU 108, or other hardware processing resource device to perform the processes described herein. Similarly, main memory 112 and static memory 114 may also contain a computer-readable medium for storage of one or more sets of machine-readable program code instructions, parameters, or profiles 118 described herein. The disk drive unit 126 or static memory 114 also contain space for data storage. Further, the machine-readable program code instructions, parameters, and profiles 118 may embody one or more of the methods as described herein. In a particular embodiment, the machine-readable program code instructions, parameters, and profiles 118 may reside completely, or at least partially, within the main memory 112, the static memory 114, and/or within the disk drive 126 during execution by the hardware processor 102, EC 104, APU 108, NPU 100, or GPU 106 of information handling system 100.

Main memory 112 or other memory of the embodiments described herein may contain computer-readable medium (not shown), such as RAM in an example embodiment. An example of main memory 112 includes random access memory (RAM) such as static RAM (SRAM), dynamic RAM (DRAM), non-volatile RAM (NV-RAM), or the like, read only memory (ROM), another type of memory, or a combination thereof. Static memory 114 may contain computer-readable medium (not shown), such as NOR or NAND flash memory in some example embodiments. The applications and associated APIs, for example, may be stored in static memory 114 or on the disk drive unit 126 that may include access to a machine-readable code instructions, parameters, and profiles 118 such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of machine-readable code instructions. The term “computer-readable medium” shall also include any medium that is capable of storing, encoding, or carrying a set of machine-readable code instructions for execution by a processor or that cause a computer system to perform any one or more of the methods or operations disclosed herein.

In an embodiment, the information handling system 100 may further include a power management unit (PMU) 128 (a.k.a. a power supply unit (PSU)). The PMU 128 may include a hardware controller and executable machine-readable code instructions to manage the power provided to the components of the information handling system 100 such as the hardware processor 102 and other hardware components described herein. The PMU 128 may control power to one or more components including the one or more drive units 126, the hardware processor 102 (e.g., CPU), the EC 104, the GPU 106, the APU 108, the NPU 110, the video/graphic display device 150, or other wired or wireless I/O devices 148 such as the mouse 158, the stylus 154, the keyboard 152, and the trackpad 156 and other components that may require power when a power button has been actuated by a user. In an embodiment, the PMU 128 may monitor power levels and be electrically coupled to the information handling system 100 in embodiments herein to provide this power. The PMU 128 may be coupled to the bus 124 to provide or receive data or machine-readable code instructions. The PMU 128 may regulate power from a power source such as the battery 130, or AC power adapter 132. In an embodiment, the battery 130 may be charged via the AC power adapter 132 and provide power to the components of the information handling system 100, via wired connections, or when AC power from the AC power adapter 132 is removed.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium 116 can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or machine-readable code instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses hardware resources executing software or firmware, as well as hardware implementations.

As described herein, the information handling system 100 includes a digital display device 150 including its light-emitting display panel 151 used by the user to receive visual output from the information handling system 100. Again, during use, a user may want to prevent onlookers and other human eavesdroppers from viewing the images, text, and other data presented on the digital display device 150. This data may be proprietary and not intended to be viewed by others. As such, the digital display device 150 may include a MIT-based metasurface privacy layer 162. This MIT-based metasurface privacy layer 162, in an embodiment, may be formed into or onto the surface of the display panel 151 of the digital display device 150 or made to be integrated into the display panel 151 thereby forming a monolithic piece within the digital display device 150. In an embodiment, the MIT-based metasurface privacy layer 162 may be formed on top of the display panel 151 of the digital display device 150 such that the MIT-based metasurface privacy layer 162 is above or outward from the display panel 151 of the digital display device 150 or, in other words, closer to the user when the user is viewing the digital display device 150. Thus, in the present specification and in the appended claims, the term “top” is meant to be understood as a location within the stack of the MIT-based metasurface privacy layer 162 and digital display device 150 that is outward or closer to the user as the user is viewing the digital display device 150 through the MIT-based metasurface privacy layer 162.

In an embodiment, the MIT-based metasurface privacy layer 162 has an MIT layer 176 that is thin enough to be transparent in some states and may include a plurality of layers that cooperate to dynamically alter the optical properties of the MIT-based metasurface privacy layer 162 and the light emitted from the digital display device 150. The MIT-based metasurface privacy layer 162 formed on top of or outward from the digital display device 150 may include a transparent cover layer 164 that serves as a protective layer over the MIT-based metasurface privacy layer 162.

In an embodiment, a nano-patch grating and diffraction layer 166 may be formed under the transparent cover layer 164. This nano-patch grating and diffraction layer 166 may include a periodic array of nanoscale optical features that are etched or patterned onto a surface of a first transparent layer 168 or otherwise sandwiched in between the transparent cover layer 164 and the first transparent layer 168. In an embodiment, the nano-patch grating and diffraction layer 166 may include patches of, for example, aluminum, gold, or other metal that are arranged in grid or lattice pattern. In an embodiment, the grating period, depth, and shape of these metallic patches of the may determine how light of images emitted from the display panel 151 of the digital display device 150 interacts with the nano-patch grating and diffraction layer 166. In an embodiment, therefore, the nano-patch grating and diffraction layer 166 may control the diffraction of light emitted from the digital display panel 151 such that light at normal incidence (e.g., emitted from the digital display panel 151) passes through the MIT-based metasurface privacy layer 162 clearly while other light that may be impeded via adjustable opaque strips of the MIT layer may be diffracted into non-useful directions to reduce viewing angles of images. As described herein, activated strips of an MIT layer by heating with selected heating line thermoelectric elements may initially absorb or reflect portions of the light emitted from the digital display panel 151 such that light rays are reflected or absorbed and interrupted as they pass to the nano-patch grating and diffraction layer 166 and refracted at oblique angles when those strip portions of the MIT layer 176 on a particular side of the digital display panel 151 transition from a transparent, insulating state to an opaque, metallic state as described herein.

As described below, the nano-patch grating and diffraction layer 166 diffracts light from the digital display device 150 (e.g., the display panel 151) and, when not affected by adjustments to the MIT layer, passes 95% or more of the light having little impact on the viewable image by the user. However, when one or more of the thermoelectric element heater lines of the first thermoelectric element layer 170 and/or second thermoelectric element layer 174 are activated with voltage to transition a corresponding linear strip of the MIT layer 176 material to an opaque, metallic state, light from the display panel 151 of the digital display device 150 passing linearly across this opaque linear strip in the MIT layer 176 is not diffracted obliquely and is still viewable at a narrower (e.g., direct) angle linearly through the nano-patch grating and diffraction layer 166. Thus, this light of images that is not diffracted obliquely by the nano-patch grating and diffraction layer 166 is not blurred to the user positioned at a central viewing angle in front of the digital display device 150. However, side viewing angles of the light from the digital display panel 151 that has passed through an opaque linear strip of the MIT layer 176 material and the of the nano-patch grating and diffraction layer 166 is diffracted obliquely to appear blurred, diminished or darkened at those wider angles such that content is not viewable in embodiments herein. As the one or more of the thermoelectric element heater lines of the first thermoelectric element layer 170 and/or second thermoelectric element layer 174 are activated towards the middle of the digital display screen from the outer sides with voltage to transition corresponding linear strips of the MIT layer 176 material to an opaque state, the viewable window without blurring caused by diffraction of the nano-patch grating and diffraction layer 166 is narrowed to a more central viewing angle of viewable images. This may also impact the authorized user however, so the narrowing of the viewable angles or width of the field of view for the images may be adjustable.

In an embodiment, a first transparent layer 168 may be formed under the nano-patch grating and diffraction layer 166. This transparent layer may be made of any type of transparent material such as glass. In an embodiment, the first transparent layer 168 may be made of an insulative material that prevents the nano-patches from touching the first thermoelectric element layer 170 and the elements thereof.

As mentioned, a first thermoelectric element layer 170 may be formed below the first transparent layer 168. The first thermoelectric element layer 170 may include a plurality of, in an embodiment, parallel addressable thermoelectric elements traversing a length, such as an x-direction of a metasurface cell, and arranged in parallel heater lines across the width, such as a y-direction of the metasurface cell. The plurality of parallel thermoelectric elements may be made of lossy indium tin oxide (ITO) such that, when a voltage is applied thereto, it heats corresponding linear strips, bands or portions of the MIT layer 176 described herein causing them to transition to a metal or opaque state. In an embodiment, the plurality of thermoelectric elements may include a plurality of addressable lossy ITO rods arranged vertically or horizontally in columns and rows, respectively, within a first thermoelectric element layer 170 and a second thermoelectric element layer 174. As described herein, these plurality of lossy ITO rods of the first thermoelectric element layer 170 may be formed perpendicular to other second plurality of lossy ITO rods formed as a second thermoelectric element layer 174 below the first thermoelectric element layer 170. In an embodiment, the plurality of ITO rods of the first thermoelectric element layer 170 may be made of lossy indium tin oxide (ITO) that is transparent and electrically conductive, though with some resistance due to the lossy resistive nature (such as due to added additional components). The ITO of the plurality of rods may be formed to be lossy such that these plurality of rods may have non-negligible electrical resistance resulting in the electrical energy being converted mostly into heat in order for the plurality of rods of ITO to heat corresponding strips or bands of the MIT layer 176.

In an embodiment, a heat conductive dielectric layer 172 may be formed below the first thermoelectric element layer 170. This dielectric layer 172 may be formed to prevent each of the plurality of rods of the first thermoelectric element layer 170 from coming into electrical contact with each of the plurality of rods of the second thermoelectric element layer 174. In an embodiment, the dielectric layer 172 may be made of any transparent, dielectric material such as aluminum oxide (Al₂O₃) that may also conduct heat to the MIT layer 176 below or inward from the first and second thermoelectric element layers 170 and 174. It is appreciated that any type of transparent, dielectric material with thermal conductivity may be used to form the dielectric layer 172 and the present specification contemplates the use of these other dielectric materials.

As mentioned above, the second thermoelectric element layer 174 may be formed under the dielectric layer 172. Similar to the first thermoelectric element layer 170, the second thermoelectric element layer 174 may include the plurality of addressable thermoelectric elements (e.g., the parallel ITO rods) that, when a voltage is applied thereto, heats the MIT layer 176 in linear strips, bands or portions corresponding to the parallel addressable thermoelectric elements described herein. In an embodiment, the plurality of thermoelectric elements may include a plurality of rods arranged vertically or horizontally in columns and rows, respectively. As described herein, these plurality of rods of the second thermoelectric element layer 174 may be formed perpendicular to other plurality of rods formed within a first thermoelectric element layer 170 formed above the second thermoelectric element layer 174. In an embodiment, the plurality of rods of the second thermoelectric element layer 174 may be made of indium tin oxide (ITO) that is formed to be lossy such that these plurality of rods may have non-negligible electrical resistance resulting in the electrical energy being converted mostly into heat in order for the plurality of rods of ITO to heat the MIT layer 176.

Further, in some embodiments, left or right sides or top or bottom portions of the one or more of the thermoelectric element heater lines of the first thermoelectric element layer 170 and/or second thermoelectric element layer 174 may be activated independently with voltage to transition a corresponding linear strip of the MIT layer 176 material to an opaque, metallic state in some embodiments. The side, top, or bottom thermoelectric element heater lines may be selected for heating to blur the viewing angle of images for light diffracted through the nano-patch grating and diffraction layer 166 on that corresponding side, top, or bottom. The side, top, or bottom location of thermoelectric element heater lines that will be selected for activation depends on a detected angle location from the human presence detection sensor 180 of an eavesdropping human presence on the left side, right side, above or even from below the user in front of the digital display device 150 in various embodiments herein. In yet further embodiments, this left or right side or top or bottom control of viewing angles by selectively addressed activation of the one or more of the thermoelectric element heater lines of the first thermoelectric element layer 170 and/or second thermoelectric element layer 174 may also be used to adjust the central cone or field of viewability of the images in a direction of the detected and identified user in front of the digital display device 150 such as when a user may move off-center. In embodiments herein, the human presence detection sensor 180, such as the LiDAR sensor, may be used to identify the user and track the location and viewing angle of the identified user in front of the display panel 151 of the digital display device 150. This tracking of the location of the authorized user is used by the machine readable code instructions of the user presence CNN executing on the metasurface hardware controller or hardware processor 102 to address one or more of the thermoelectric element heater lines of first thermoelectric element layer 170 and/or second thermoelectric element layer 174 to eliminate heating of some thermoelectric element heater lines or add heating of others and dynamically adjust the restrictions on viewing angles being implemented to allow viewability centrally toward the shifted location of the identified user.

As described herein, the MIT layer 176 may be formed below the second thermoelectric element layer 174. The MIT layer 176 may be made of any type of transparent metal-insulator-transition (MIT) material. In an embodiment, this transparent, MIT material may include vanadium dioxide (VO₂). As described herein, the MIT material may be transparent or nearly transparent when cool, such as at room temperatures. When heat is applied to a portion of the surface of the MIT layer 176, the MIT material transitions to an opaque, metallic state thereby preventing or interfering with some light emitted from the digital display device 150 passing through the MIT-based metasurface privacy layer 162. As such, by selectively heating or not heating the MIT layer 176 with the plurality of rods of the first thermoelectric element layer 170 and second thermoelectric element layer 174, the corresponding strips or band portions of the surface of the MIT layer 176 may be selectively made to be transparent or opaque.

During operation, the information handling system 100 or the metasurface hardware controller of the MIT-based metasurface privacy layer 162 may also implement a human presence detection sensor 180 to determine when to activate the plurality of thermoelectric elements of the first thermoelectric element layer 170 and the second thermoelectric element layer 174 in order to selectively transition the MIT layer 176 to an opaque state and thereby create one or more narrowed viewing angles for displayed images with wider angles blurred or altered to be unviewable. In an embodiment, the human presence detection sensor 180 may include any sensor that can detect the presence and movement of humans such as the user and any human eavesdroppers at or around the information handling system 100. In an embodiment, the human presence detection sensor 180 may be a light detecting and ranging (LiDAR) sensor. In an embodiment, this LiDAR sensor or other human presence detection sensor 180 may be placed in a bezel above the display panel 151 of the digital display device 150. In an embodiment, the human presence detection sensor 180 may be used not only to detect the presence and movement of the user or a human eavesdropper, but may also be used to capture an image of the user or human eavesdroppers and recognize facial features in order to identify and distinguish an authorized user of the information handling system 100 from other human forms. In an embodiment, the human presence detection sensor 180 may also detect other humans from face or head identification at other angles and ranges within the background of the user. In some embodiments, a camera (not shown), such as a web camera may also be mounted on the digital display device 150 and used in coordination with facial recognition software to identify an authorized user.

In an embodiment, the output from the human presence detection sensor 180 may be provided to the hardware processor 102 of the information handling system 100 or the metasurface hardware controller of the MIT-based metasurface privacy layer 162 depending on which one executes machine readable code instructions of the user presence CNN algorithm in various embodiments. This output may include identification of an angle and range of a user and angles and ranges of any other detected humans to determine whether a human eavesdropper is present. The hardware processor 102 or metasurface controller may then use this output from the human presence detection sensor 180 as input to a human presence convolutional neural network (CNN) algorithm 184. In an embodiment, therefore, the hardware processor 102 or metasurface controller may execute machine readable code instructions of the human presence CNN algorithm 184 in order to detect and identify positions and identities of human eavesdroppers around the digital display device and identify which of the plurality of thermoelectric material rods of the first thermoelectric element layer and which of the plurality of thermoelectric material rods of the second thermoelectric element layer to apply a voltage to. In an embodiment, the thermoelectric elements of the first thermoelectric element layer 170 and/or second thermoelectric element layer 174 form a grid over the MIT layer 176 and may, individually, be heated in order to switch linear strip portions of the MIT layer 176 from a transparent insulative state to an opaque metallic state, or which of the thermoelectric elements to cease heating if heating is already being applied. The thermoelectric element heater lines may be parallel heater lines spanning from a left side to a right side, for example in the first thermoelectric element layer 170, and parallel heater lines spanning from a bottom side to a top side, for example in the second thermoelectric element layer 170 to form a grid in an example embodiment herein. This order of vertical and horizontal may be switched between the first thermoelectric element layer 170 and the second thermoelectric element layer 174 or other orientations are contemplated in various embodiments.

In order to identify the user, the human presence CNN algorithm 184 may be provided with access to a facial features library that includes features of the user's face for comparison to those facial features detected by the human presence detection sensor 180 as input. As described, a web camera or other camera and facial recognition software may be used in yet other embodiments to identify an authorized user and differentiate other eavesdropper humans. When the human presence CNN algorithm 184 has identified other human eavesdroppers at or around the information handling system 100, the human presence CNN algorithm 184 may also determine which, if any, of the plurality of thermoelectric elements of either or both of the first thermoelectric element layer 170 and second thermoelectric element layer 174 should have a voltage applied thereto in order to heat those thermoelectric elements. It is appreciated that any type of machine learning algorithm may be used to determine the location, movement, and identity of those humans around the digital display device 150 and the present specification contemplates the use of these other machine learning algorithms.

The hardware processor 102 or metasurface hardware controller may receive this output from the execution of the human presence CNN algorithm 184 and direct a metasurface hardware microcontroller to, with the PMU 128 or a metasurface PMU, apply a voltage to those identified thermoelectric elements of the first thermoelectric element layer 170 and second thermoelectric element layer 174 on given left, right, top or bottom sides that can be used to change, at least, portions of the MIT layer 176 from its transparent state to its opaque metallic state to impede or blur viewability of images on a side of a detected eavesdropper human. As described herein, a metasurface microcontroller unit at the MIT-based metasurface privacy layer 162 may be used to provide voltage from a voltage source such as a PMU to address selected thermoelectric element heater lines or rods from the first thermoelectric element layer 170 or second thermoelectric element layer 174 based on the determination from the execution of the human presence CNN algorithm as to location of the identified user and any identification of eavesdropper human presences and which thermoelectric elements from the first thermoelectric element layer 170 or second thermoelectric element layer 174 to activate or heat. It is appreciated that a portion of the identified thermoelectric elements (the plurality of rods of ITO) may be activated instead of all of them within the first thermoelectric element layer 170 and the second thermoelectric element layer 174 and a number of identified thermoelectric element heater lines from a given side may be selected to control how narrow the viewing angle is limited from that side of the digital display panel 151. Indeed, if a human eavesdropper were to be detected on the left side of the information handling system 100, one or more of those thermoelectric elements on the left side of the digital display device 150 may be activated to obfuscate the left side of the digital display device 150 instead of the whole digital display device 150 depending on how far on the left side that the eavesdropper human is detect. Similar control may be applied to a right side, top side, or bottom side in embodiments herein. Further, in some embodiments, pairs of thermoelectric elements on both the left side and right side of the digital display device 150 may be activated to obfuscate the sides of images of the digital display panel 151 when plural eavesdroppers are detected in a background. Similarly, pairs of top or bottom thermoelectric elements on the bottom and top side of the digital display panel 151 may be used to further narrow the field of view for viewable displayed images in other embodiments.

The MIT-based metasurface privacy layer 162 allows for precise control of transitioning between a transparent state to an opaque state of the MIT layer 176 to create limits on viewing angles with the nano-patch grating and diffraction layer 166 that prevent human eavesdroppers from viewing the content presented to the user on the digital display device 150. The ultra-thin MIT layer 176, grating of thermoelectric elements within the first thermoelectric element layer 170 and second thermoelectric element layer 174, and nano-patch grating and diffraction layer 166 may maintain the transparency of the MIT-based metasurface privacy layer 162 above 95% and without impacting the resolution of the images presented by the digital display device 150. With the integration of the human presence detection sensor 180 (e.g., LiDAR) and the MIT layer 176 allows on-the-fly privacy protection without the need for manual intervention or additional physical components at the information handling system 100. Additionally, the use of machine learning algorithms such as the human presence CNN algorithm 184 to monitor the environment around the information handling system 100 for human presence and dynamically adjust the MIT-based metasurface privacy layer 162 in real-time to ensure that the viewing angle for viewability of the images adapts based on the shifting location of an authorized user or based on presence of potential observers and human eavesdroppers.

When referred to as a “system,” a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include hardware processing resources executing software, including firmware embedded at a device, such as an Intel® brand processor, AMD® brand processors, Qualcomm® brand processors, or other processors and chipsets, or other such hardware device capable of operating a relevant software environment of the information handling system. The system, device, controller, or module can also include a combination of the foregoing examples of hardware or hardware executing software or firmware. Note that an information handling system can include an integrated circuit or a board-level product having portions thereof that can also be any combination of hardware and hardware executing software. Devices, modules, hardware resources, or hardware controllers that are in communication with one another need not be in continuous communication with each other, unless expressly specified otherwise. In addition, devices, modules, hardware resources, and hardware controllers that are in communication with one another can communicate directly or indirectly through one or more intermediaries.

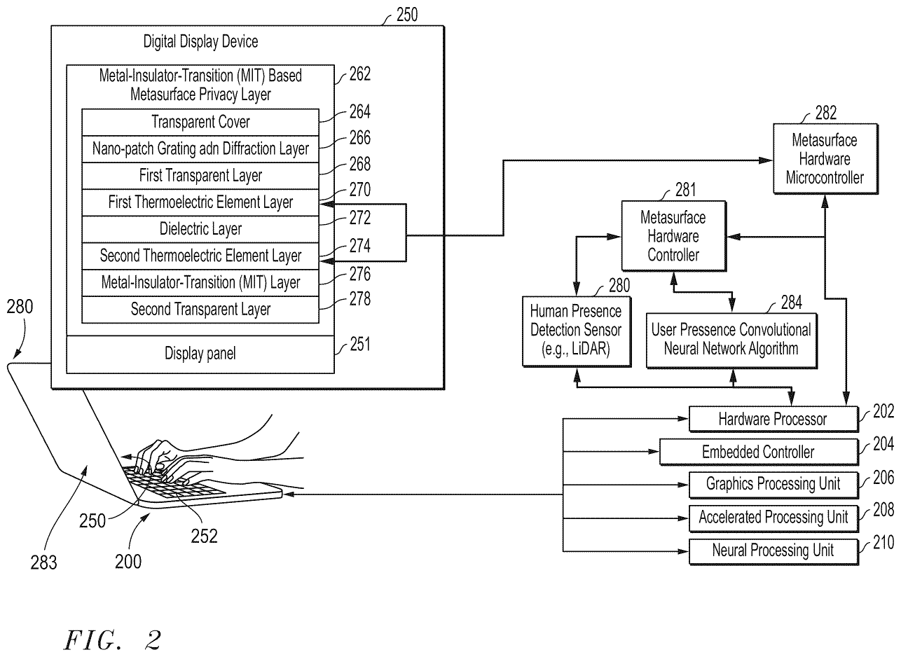

FIG. 2 is a block diagram illustrating an information handling system 200 comprising a digital display device 250 including a display panel 251 that implements an MIT-based metasurface privacy layer 262 that includes an MIT layer 276 of adjustable opacity material with selective application of thermoelectric heating elements according to another embodiment of the present disclosure. As described herein, the MIT-based metasurface privacy layer 262 may be used by the user of the information handling system 200 to create privacy at the user's digital display device 250. For example, the user may be a business professional that has taken the user's laptop-type information handling system 200 to an airport or café. The user may wish to work on the user's information handling system 200 and, during the course of this work, may have to display sensitive documents or other proprietary information on the digital display device 250. The MIT-based metasurface privacy layer 262 described here includes a MIT layer 276 that, along with other layers within the digital display device 250, dynamically adjusts the viewing angle of the user's digital display device 250, ensuring viewing the content of displayed images may be limited to the user directly in front of the display panel 251. If some other human such as the human eavesdroppers mentioned herein attempts to view the digital display device 250 from the side, the MIT-based metasurface privacy layer 262 reacts by narrowing the viewing angle, rendering the content blurred or blocked to anyone not directly in front of the digital display device 250. The systems and methods described herein provide peace of mind to the user, allowing the user to work securely in various environments without the need for additional physical privacy screens to obfuscate the content presented thereon.

In an embodiment, the MIT-based metasurface privacy layer 262 has an MIT layer 276 that is thin enough to be transparent in some states and may include a plurality of layers that cooperate to dynamically alter the optical properties of the MIT-based metasurface privacy layer 262 and the light emitted as images from display panel 251 of the digital display device 250. The MIT-based metasurface privacy layer 262 formed on top of the digital display device 250 may include a transparent cover layer 264 that serves as a protective outer layer of the MIT-based metasurface privacy layer 262.

In an embodiment, a nano-patch grating and diffraction layer 266 is formed under the transparent cover layer 264. This nano-patch grating and diffraction layer 266 may include a periodic array of nanoscale optical features that are etched or patterned onto a surface of a first transparent layer 268 or otherwise sandwiched in between the transparent cover layer 264 and the first transparent layer 268. In an embodiment, the nano-patch grating and diffraction layer 266 may include patches of, for example, aluminum, gold, or other metal that are arranged in grid or lattice pattern. In an embodiment, the grating period, depth, and shape of these metallic patches of they may determine how light emitted from the digital display panel 251 interacts with the nano-patch grating and diffraction layer 266. In an embodiment, therefore, the nano-patch grating and diffraction layer 266 may control the diffraction of light emitted from the digital display panel 251 such that, in some embodiments, light at normal incidence (e.g., emitted from the digital display device 250) passes through the MIT-based metasurface privacy layer 262 clearly with limited impact to clarity of the displayed image. In another embodiment, selective transitioning of strip portions of the MIT layer 276 to an opaque state may interfere with images and light of those images diffracted along selected left, right, top or bottom sides of the display panel into non-useful directions by nano-patch grating and diffraction layer 266 at wide angles outside an field of view of the images towards a central axis from the selected side or sides. As described herein, opaque strip portions of the MIT layer 276 as transitioned by application of heat may initially absorb or reflect and interfere with portions of the light emitted for images from the digital display panel 251 such that light rays diffracted at non-usable oblique angles along one or more sides by the nano-patch grating and diffraction layer 266 when the MIT layer 276 or portions thereof transition from a transparent, insulating state to an opaque, metallic state as described herein.

As described below, the nano-patch grating and diffraction layer 266 diffracts light from the digital display device 250 (e.g., the display panel 251) and when not affected by adjustments to the MIT layer passes 95% or more of the light having little impact on the viewable image by the user. However, when one or more of the thermoelectric element heater lines of the first thermoelectric element layer 270 and/or second thermoelectric element layer 274 are activated with voltage to transition a corresponding linear strip of the MIT layer 276 material to an opaque, metallic state, light from the display panel 251 of the digital display device 250 passing linearly across this opaque linear strip in the MIT layer 276 and at a narrow (e.g., direct) angle linearly through the nano-patch grating and diffraction layer 266 is not diffracted or blurred to the user positioned at a central viewing angle in front of the digital display device 250. However, side viewing angles of the light for displayed images from the digital display panel 250 that has passed through an opaque linear strip of the MIT layer 276 material and the of the nano-patch grating and diffraction layer 266 is diffracted to appear blurred, diminished or darkened at wider angles from the display panel 251 outside a central field of view such that content is not viewable in embodiments herein. As the one or more of the thermoelectric element heater lines of the first thermoelectric element layer 270 and/or second thermoelectric element layer 274 are activated towards the middle of the digital display screen from the outer sides with voltage to transition corresponding linear strips of the MIT layer 276 material to an opaque state, the viewable window angle without blurring caused by diffraction of the nano-patch grating and diffraction layer 266 is narrowed to the center field of view in front of the display panel 251 from any given side activated.

In an embodiment, a first transparent layer 268 may be formed under the nano-patch grating and diffraction layer 266. This transparent layer may be made of any type of transparent material such as glass. In an embodiment, the first transparent layer 268 may be made of an insulative material that prevents the nano-patches from touching the first thermoelectric element layer 270 and the elements thereof.

As mentioned, a first thermoelectric element layer 270 may be formed below the first transparent layer 268. The first thermoelectric element layer 270 may include a plurality of parallel thermoelectric elements traversing a length, such as an x-direction of a metasurface cell, and arranged in parallel heater lines across the width, such as a y-direction of the metasurface cell. The plurality of parallel thermoelectric elements may be made of lossy indium tin oxide (ITO) such that, when a voltage is applied thereto, heats corresponding linear strips or band portions of the MIT layer 276 described herein causing them to transition to a metal or opaque state. In an embodiment, the plurality of thermoelectric elements may include a plurality of addressable lossy ITO rods arranged vertically or horizontally in columns and rows, respectively. As described herein, these plurality of ITO rods of the first thermoelectric element layer 270 may be formed perpendicularly to other second plurality of ITO rods formed as a second thermoelectric element layer 274 below the first thermoelectric element layer 270. In an embodiment, the plurality of ITO rods of the first thermoelectric element layer 270 may be made of lossy indium tin oxide (ITO) that is transparent. The ITO of the plurality of rods may be formed to be lossy such that these plurality of rods may have non-negligible electrical resistance resulting in the electrical energy being converted mostly into heat in order for the plurality of rods of ITO to heat the MIT layer 276.

In an embodiment, a heat conductive dielectric layer 272 may be formed below the first thermoelectric element layer 270. This dielectric layer 272 may be formed to prevent each of the plurality of rods of the first thermoelectric element layer 270 from coming into contact with each of the plurality of rods of the second transparent layer 278. In an embodiment, the dielectric layer 272 may be made of any transparent, dielectric material such as aluminum oxide (Al₂O₃). It is appreciated that any type of transparent, dielectric material may be used to form the dielectric layer 272 and the present specification contemplates the use of these other dielectric materials.

As mentioned above, the second thermoelectric element layer 274 may be formed under the dielectric layer 272. Similar to the first thermoelectric element layer 270, the second thermoelectric element layer 274 may include the plurality of addressable thermoelectric elements (e.g., the parallel to ITO rods) that, when a voltage is applied thereto, heats the MIT layer 276 in linear strips of band portions corresponding to the parallel addressable thermoelectric elements described herein. In an embodiment, the plurality of thermoelectric elements may include a plurality of rods arranged vertically or horizontally in columns and rows, respectively. As described herein, these plurality of rods of the second thermoelectric element layer 274 may be formed perpendicular to other plurality of rods formed within a first thermoelectric element layer 270 formed above the second thermoelectric element layer 274. In an embodiment, the plurality of rods of the second thermoelectric element layer 274 may also be made of lossy indium tin oxide (ITO) that is transparent. Again, the ITO of the plurality of rods may be formed to be lossy such that these plurality of rods may have non-negligible electrical resistance resulting in the electrical energy being converted mostly into heat in order for the plurality of rods of ITO to heat the MIT layer 276.

Further, in some embodiments, left or right sides or top or bottom portions of the one or more of the thermoelectric element heater lines of the first thermoelectric element layer 270 and/or second thermoelectric element layer 274 may be activated independently with voltage to transition a corresponding linear strip of the MIT layer 276 material to an opaque, metallic state in some embodiments. The side, top, or bottom thermoelectric element heater lines may be selected for heating to blur the viewing angle through the nano-patch grating and diffraction layer 266 on that corresponding side, top, or bottom depending on a detected viewing angle location from the human presence detection sensor 280 of an eavesdropping human presence on one or another side, or above or below the user in front of the digital display device 250 in various embodiments herein. In yet further embodiments, the viewing angles on a left, right, top or bottom side may be controlled by selectively addressing activation of the one or more of the thermoelectric element heater lines of the first thermoelectric element layer 270 and/or second thermoelectric element layer 274. This control of viewing angles on one or more selected sides of the display panel 251 is used to adjust the cone or field of viewability in a direction of the detected and identified user in front of the digital display device 250 such as when a user may move off-center. In embodiments herein, the human presence detection sensor 280, such as the LiDAR sensor, may be used to identify the user and track the location and viewing angle of the identified user in front of the display panel 251 of the digital display device 250 and address one or more of the thermoelectric element heater lines of first thermoelectric element layer 270 and/or second thermoelectric element layer 274 based on output from the user presence CNN executing on the hardware processor (e.g., hardware processor 202) to dynamically adjust the restrictions on viewing angles being implemented to allow viewability toward the shifted location of the identified user.

As described herein, the MIT layer 276 may be formed below the second thermoelectric element layer 274. The MIT layer 276 may be made of any type of transparent metal-insulator-transition (MIT) material. In an embodiment, this transparent, MIT material may include vanadium dioxide (VO₂). As described herein, the MIT material may be transparent or nearly transparent when cooled or at room temperatures. When heat is applied to a portion of the surface of the MIT layer 276, the MIT material transitions to an opaque, metallic state thereby preventing some light emitted from the digital display device 250 from passing through the MIT-based metasurface privacy layer 262. As such, by selectively heating or not heating portions of the MIT layer 276 with the plurality of rods of the first thermoelectric element layer 270 or the second thermoelectric element layer 274, the portions of the surface of the MIT layer 276 may be selectively made to be transparent or opaque and selectively interfere or not with light for images displayed from the display panel 251.

It is appreciated that light emitted for displayed images from display panel 251 of the digital display device 250 at near-normal incidence passes directly through the layered stack with minimal distortion. However, when opaque strips or panels the MIT layer 276 is activated via conversion from a transparent state to the opaque state via application of heat from the thermoelectric elements of the first thermoelectric element layer 270 and/or second thermoelectric element layer 274, this interference of light along selected sides of the display panel 251 causes interaction with the nano-patch grating and diffraction layer 266. The interference by the opaque portions of the MIT layer 276 causes diffraction and blur by the nano-patch grating and diffraction layer 266 at wider angles outside the core field of view from the display panel 251 while allowing light of the displayed image at central field of view angles through thereby reducing visibility from off-axis viewing angles by human eavesdroppers.

As described herein, the MIT layer 276 may be dynamically transitioned from its transparent state to its opaque state (and vice versa) based on detection of other humans at or around the digital display device 250. Again, the thermoelectric elements of the first thermoelectric element layer 270 and/or second thermoelectric element layer 274 form a grid over a MIT layer 276 and may, individually, be heated in order to switch linear strip portions of the MIT layer 276 from a transparent insulative state to an opaque metallic state, or which of the thermoelectric elements to cease heating if heating is already being applied. In an embodiment, the hardware processor 202 or a metasurface hardware controller 281 may interface with a human presence detection sensor 280 that may include a LiDAR sensor as described herein. This human presence detection sensor 280 may not only detect the presence of other humans at or about the digital display device 250 but may also detect movement of the user as well as facial features that are used by the hardware processor 202 to identify the human and compare those facial features to that of the user/owner of the information handling system 200. In some embodiments, a parallel camera, such as a web camera, with facial recognition software may be used along with the human presence detection sensor 280 to identify an authorized user in front of the digital display device 250. The present specification contemplates that other hardware processing devices such as an EC 204, a GPU 206, an APU 208, and an NPU 210 may be used in place of or in addition to the hardware processor 202 or the metasurface hardware controller 281 in order to execute the machine readable code instructions described herein.

When the human presence detection sensor 280 has detected another human, the hardware processor 202 or the metasurface hardware controller 281 may receive this range and angle data for location of such a human presence relative to the display panel 251 from the human presence detection sensor 280. In an embodiment, the hardware processor 202, an NPU 210, or the metasurface hardware controller 281 may execute the machine readable code instructions of a trained human presence CNN algorithm 284. The range and angle data for location of the user or one or more detected eavesdropper humans from the human presence detection sensor 280 is input to the human presence CNN algorithm 284 to determine the location of the detected human, the movement of the detected human, and, in some embodiments, the identity of the human as an authorized user, for example. In an embodiment, where execution of machine readable code instructions of the human presence CNN algorithm 284 has identified the detected human as someone other than the user/owner of the information handling system 200 (e.g., via facial comparisons to an identified user) the output from the human presence CNN algorithm 284 may inform the hardware processor 202 or the metasurface hardware controller 281 of the detection of a human eavesdropper presence. The output from the human presence CNN algorithm 284 may also provide data describing which of the thermoelectric elements of each of the first thermoelectric element layer 270 and second thermoelectric element layer 274 on one or more sides to provide voltage to in order to provide heat to specific locations across the surface of the MIT layer 276 thereby transitioning portions of the MIT layer 276 from transparent to opaque as described herein. This is used to narrow the field of view for the displayed images from the display panel 251 and blur wider angles to prevent unauthorized viewing of images by detected eavesdroppers outside the narrowed field of view.

With this output data from the hardware processor 202 (or NPU 210, for example), the hardware processor 202 may direct a metasurface hardware microcontroller 282 how to provide voltages to the thermoelectric elements. In other embodiments, the machine readable code instructions of a trained user presence CNN algorithm 284 may execute on a metasurface hardware controller 281, such as an FPGA, and output data from the hardware controller may direct a metasurface hardware microcontroller 282 how to provide voltages to the thermoelectric elements. As described herein, a microcontroller unit at the MIT-based metasurface privacy layer 262 may be used to provide voltage from a voltage source such as a PMU to address selected thermoelectric element heater lines or rods from the first thermoelectric element layer 270 and/or second thermoelectric element layer 274 based on the determination from the execution of the human presence CNN algorithm as to location of the identified user and any identification of eavesdropper human presences on a side having those selected thermoelectric elements from the first thermoelectric element layer 270 or second thermoelectric element layer 274 to activate or heat. In an embodiment, the metasurface hardware microcontroller 282 may address each of the thermoelectric elements individually such that corresponding strips or portions of the MIT layer 276 may be changed from its transparent state to its opaque state along one or more sides of the display panel 251. This allows for the control of viewing angles to be narrowed at portions of the MIT-based metasurface privacy layer 262 instead of across the entire surface of the MIT-based metasurface privacy layer 262 in embodiments herein by selection of one or more thermoelectric element heater lines on one or more left, right, top or bottom sides in embodiments herein. In an embodiment, as the human presence detection sensor 280 detects changes in the environment and presence of humans or not, this data may be relayed again to the hardware processor 202 or metasurface hardware controller 281 for execution of the machine readable code instructions of the human presence CNN algorithm 284 as described herein to track location of one or more eavesdroppers or movement of the user and adjust the activation or deactivation of the thermoelectric elements of the MIT-based metasurface privacy layer 262 to narrow or expand the width of the field of view for the displayed images. Thus, the dynamic creation and undoing if the viewing angles allows for maximum privacy for the user while also reducing power consumption when the creation of the viewing angles is not needed due to no presence of human eavesdroppers.

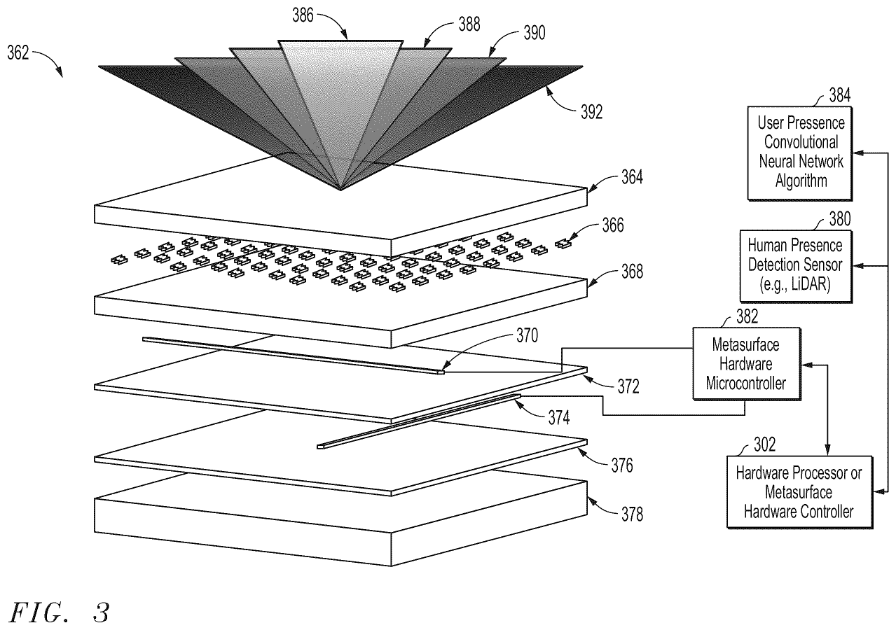

FIG. 3 is an exploded perspective view diagram showing a MIT-based metasurface privacy layer 362 of a digital display device including an adjustable MIT layer with adjustable opacity from thermoelectric heating elements and a nano-patch grating and diffraction layer according to an embodiment of the present disclosure. As described herein, this MIT-based metasurface privacy layer 362 may be formed over a digital display device or may be made an integral part of the digital display panel of the digital display device.

In an embodiment, the MIT-based metasurface privacy layer 362 has an MIT layer 376 thin enough to be transparent in some states and may include a plurality of layers that cooperate to dynamically alter the optical properties of the MIT-based metasurface privacy layer 362 and the light emitted from the digital display device 350 for privacy limitations on width of viewing angles of images. The MIT-based metasurface privacy layer 362 formed on top of the digital display device 350 may include a transparent cover layer 364 that serves as a protective layer over the MIT-based metasurface privacy layer 362.

In an embodiment, a nano-patch grating and diffraction layer 366 may be formed under the transparent cover layer 364. This nano-patch grating and diffraction layer 366 may include a periodic array of nanoscale optical features that are etched or patterned onto a surface of a first transparent layer 368 or otherwise sandwiched in between the transparent cover layer 364 and the first transparent layer 368. In an embodiment, the nano-patch grating and diffraction layer 366 may include patches of, for example, aluminum, gold, or other metal that are arranged in grid or lattice pattern and diffract light of images from the digital display panel. In an embodiment, the grating period, depth, and shape of these metallic patches of the may determine how light emitted from the digital display device 350 interacts with the nano-patch grating and diffraction layer 366. In an embodiment, therefore, the nano-patch grating and diffraction layer 366 may control the diffraction of light emitted from the digital display device 350 such that, in some embodiments, light at normal incidence (e.g., emitted from the digital display device 350) passes through the MIT-based metasurface privacy layer 362 clearly with very limited alteration to clarity of viewability for images. However, other light such as light of images altered by adjustment of opacity of linear strips or portions of the MIT layer 376 may be diffracted at non-central angles on the side of the opaque strips or portions of the MIT layer into non-useful directions causing blur or suppression of the images at those non-central angles. As described herein, opaque strips or portions activated in a metal-insulator-transition (MIT) layer may initially absorb or reflect portions to interfere with the light of images emitted from the digital display device 350 such that light rays are diffracted or reflected at oblique angles by the nano-patch grating and diffraction layer 366 when the MIT layer 376 or strips or portions thereof transition from a transparent, insulating state to an opaque, metallic state as described herein.

In an embodiment, a first transparent layer 368 may be formed under the nano-patch grating and diffraction layer 366. This transparent layer may be made of any type of transparent material such as glass. In an embodiment, the first transparent layer 368 may be made of an insulative material that prevents the nano-patches from touching the first thermoelectric element layer 370 and the elements thereof.

As mentioned, a first thermoelectric element layer 370 may be formed below the first transparent layer 368. The first thermoelectric element layer 370 may include a plurality of thermoelectric elements that, when a voltage is applied thereto, heats the MIT layer 376 described herein. In an embodiment, the plurality of thermoelectric elements may include a plurality of rods arranged vertically or horizontally in columns and rows, respectively. Although FIG. 3 shows a single thermoelectric element, the present specification contemplates that multiple thermoelectric elements may be formed in the first transparent layer 368 and the single thermoelectric element shown in FIG. 3 is merely an example used to show an operative connection to a metasurface hardware microcontroller 382. As described herein, these plurality of thermoelectric element linear heater rods of the first thermoelectric element layer 370 may be formed parallel to one another and perpendicular to a second plurality of rods formed within a second thermoelectric element layer 374 formed below the first thermoelectric element layer 370. The second plurality of rods formed within the second thermoelectric element layer 374. In an embodiment, the plurality of rods of the first thermoelectric element layer 370 may be made of lossy indium tin oxide (ITO). The ITO of the plurality of rods may be formed to be lossy such that these plurality of rods may have non-negligible electrical resistance resulting in the electrical energy being converted mostly into heat in order for the plurality of rods of ITO to heat the MIT layer 376.

In an embodiment, a dielectric layer 372 may be formed below the first thermoelectric element layer 370. This dielectric layer 372 may be formed to prevent each of the plurality of rods of the first thermoelectric element layer 370 from coming into contact with each of the plurality of rods of the second thermoelectric element layer 374, but may still be thermally conductive. In an embodiment, the dielectric layer 372 may be made of any transparent, dielectric material such as aluminum oxide (Al₂O₃). It is appreciated that any type of transparent, dielectric material may be used to form the dielectric layer 372 and the present specification contemplates the use of these other dielectric materials.

As mentioned above, the second thermoelectric element layer 374 may be formed under the dielectric layer 372. Similar to the first thermoelectric element layer 370, the second thermoelectric element layer 374 may include a plurality of thermoelectric elements that, when a voltage is applied thereto, heats the MIT layer 376 as described herein. Again, although FIG. 3 shows a single thermoelectric element, the present specification contemplates that multiple thermoelectric elements may be formed in the second thermoelectric element layer 374 and the single thermoelectric element shown in FIG. 3 is merely an example used to show an operative connection to a metasurface hardware microcontroller 382. In an embodiment, the plurality of thermoelectric elements may include a plurality of thermoelectric element heater line rods arranged vertically or horizontally in columns and rows, respectively. As described herein, these plurality of thermoelectric element heater line rods of the second thermoelectric element layer 374 may be formed perpendicular to other plurality of rods formed within a first thermoelectric element layer 370 formed above the second thermoelectric element layer 374. In an embodiment, the plurality of rods of the second thermoelectric element layer 374 may also be made of indium tin oxide (ITO). Again, the ITO of the plurality of rods may be formed to be lossy such that these plurality of rods may have non-negligible electrical resistance resulting in the electrical energy being converted mostly into heat in order for the plurality of rods of ITO to heat the MIT layer 376.

It is appreciated that the metasurface hardware microcontroller 382 may be operatively coupled to each of the individual thermoelectric elements of the first thermoelectric element layer 370 and the second thermoelectric element layer 374 in order to provide a voltage thereto. In an embodiment, electrical lines may be run through the dielectric layer 372, the MIT layer 376, and a base transparent layer 378 under the MIT layer 376 so that each of the thermoelectric elements may be electrically coupled to the metasurface hardware microcontroller 382. However, the present specification contemplates that the electrical leads operatively coupling the thermoelectric elements of the first transparent layer 368 and the second thermoelectric element layer 374 may be formed through any layer within the MIT-based metasurface privacy layer 362 so that a voltage can be selectively applied to any of the individual thermoelectric elements of these layers. These leads may be made of non-lossy ITO or another transparent conductor that is transparent in areas of the MIT-based metasurface privacy layer 362 where light is expected to pass from images displayed on the digital display panel (which would be oriented under base transparent layer 378 in the embodiment shown in FIG. 3).

As described herein, the MIT layer 376 may be formed below the second thermoelectric element layer 374. The MIT layer 376 may be made of any type of transparent metal-insulator-transition (MIT) material. In an embodiment, this transparent, MIT material may include vanadium dioxide (VO₂). As described herein, the MIT material may be transparent or nearly transparent when cooled or at room temperatures. When heat is applied to a portion of the surface of the MIT layer 376, the MIT material transitions to an opaque, metallic state thereby preventing or interfering with some light emitted from the digital display device 350 as displayed images as that light is passed through the nano-patch grating and diffraction layer 366 of the MIT-based metasurface privacy layer 362 causing oblique angles of diffraction at wider angles from the nano-patch grating and diffraction layer 366. As such, by selectively heating or not heating the MIT layer 376 with the plurality of rods of the first thermoelectric element layer 370 and second thermoelectric element layer 374, the portions of the surface of the MIT layer 376 may be selectively made to be transparent or opaque thus increasing the blur applied to wider angles and narrowing the image viewable field from the display panel.

It is appreciated that light emitted from the digital display device 350 at near-normal incidence passes directly through the layered stack with minimal distortion. However, when the MIT layer 376 is activated via conversion from a transparent state to an opaque state via application of heat form the thermoelectric elements of the first thermoelectric element layer 370 and/or second thermoelectric element layer 374, light interferes with the stirps of opaque MIT layer 376 parallel to sides of the display panel and is diffracted at oblique angles when interacting with the nano-patch grating and diffraction layer 366 which redirects or blocks this light, thereby reducing the width of a field of view and reducing visibility from off-axis angles by human eavesdroppers. Again, the nano-patch grating and diffraction layer 366 diffracts light from the digital display device 350 (e.g., the display panel FIGS. 2, 251) and, when not affected by adjustments to the MIT layer, passes 95% or more of the light having little impact on the viewable image by the user. However, when one or more of the thermoelectric element heater lines of the first thermoelectric element layer 370 and/or second thermoelectric element layer 374 are activated with voltage to transition a corresponding linear strip of the MIT layer 376 material to an opaque, metallic state, light from the display panel 351 of the digital display device 350 passing linearly across this opaque linear strip in the MIT layer 376 and at a narrow (e.g., direct) angle linearly through the nano-patch grating and diffraction layer 366 is still not diffracted or blurred to the user positioned at a central viewing angle in front of the digital display device 350. However, side viewing angles of the light from the digital display device 350 that has passed through an opaque linear strip of the MIT layer 376 material and the of the nano-patch grating and diffraction layer 366 is diffracted to appear blurred, diminished or darkened by oblique diffraction from the nano-patch grating and diffraction layer 366 such that content is not viewable in embodiments herein. As the one or more of the thermoelectric element heater lines of the first thermoelectric element layer 370 and/or second thermoelectric element layer 374 are activated towards the middle of the digital display screen from the outer sides with voltage to transition corresponding linear strips of the MIT layer 376 material to an opaque state, the viewable window, without blurring caused by diffraction of the nano-patch grating and diffraction layer 366, is narrowed towards the center of a narrowed viewing angle from those one or more sides. In other words, the blurring caused by diffraction of the nano-patch grating and diffraction layer 366 is increased towards the middle by the greater number of opaque strips of MIT layer 376 activated towards the middle from the side of the display panel.

In an embodiment, pairs of the thermoelectric element heater lines of the first thermoelectric element layer 370 and/or second thermoelectric element layer 374 may be progressively activated towards the middle of the digital display screen from the outer sides with voltage to transition corresponding linear strips of the MIT layer 376 material to an opaque state to narrow the viewable window, without blurring caused by diffraction of the nano-patch grating and diffraction layer 366, towards the center from both sides. This may done, for example, when plural eavesdroppers are detected or when a location is determined as public enough that eavesdroppers are consistently detected in the background. In other words, the blurring caused by diffraction of the nano-patch grating and diffraction layer 366 is increased towards the middle by the greater number of pairs of opaque strips of MIT layer 376 activated towards the middle from the sides of the display panel.

As described herein, the metasurface hardware microcontroller 382 may be operatively coupled to a hardware processor or metasurface hardware controller 302. The hardware processor or metasurface hardware controller 302 may interface with a human presence detection sensor 380 that detects the presence (or lack thereof) of other humans near the digital display device and the MIT-based metasurface privacy layer 362. Upon detection of another human besides the user, the output from the human presence detection sensor 380 may be used as input to a human presence CNN algorithm 384 for the human presence CNN algorithm 384 to determine which of the thermoelectric elements of the first thermoelectric element layer 370 and/or second thermoelectric element layer 374 are to be heated in order to switch portions of the MIT layer 376 from a transparent state to an opaque state.

When the MIT layer 376 is transitioned from the transparent state to the opaque state, one or more viewing angles 386, 388, 390, 392 of varying widths may be dynamically created. The viewing angles 386, 388, 390, 392 of varying widths shown in the embodiment of FIG. 3 are shown as symmetrical as if generated by activating pairs of thermoelectric element heater lines on opposite sides, but it is understood that viewing angles 386, 388, 390, 392 of varying widths may be non-symmetrical towards one side or the other or the top or bottom in various embodiments of the present disclosure. This is useful for adjusting to tracking of movements for an identified, authorized user or for adjusting to location of a single eavesdropper human, such as located on one side for example. The activation of a certain number of thermoelectric elements of the first thermoelectric element layer 370 and/or the second thermoelectric element layer 374 may create various angles of the viewing angle in order to prevent a human eavesdropper from viewing the digital display device at certain angles. The creation of a specific viewing angle 386, 388, 390, 392 may be dependent on the position of the human eavesdropper as detected by the human presence detection sensor 380. For example, where the human eavesdropper is detected at a first angle relative to the MIT-based metasurface privacy layer 362 and digital display device, a first viewing angle 386 may be created that allows for only the user, directly in front of the MIT-based metasurface privacy layer 362 to see image content displayed form the display panel of the digital display device. This viewing angle may change to a second viewing angle 488, a third viewing angle 490, or an n^{th} viewing angle 392 as the human eavesdropper moves off axis from the center of the MIT-based metasurface privacy layer 362. This allows the MIT-based metasurface privacy layer 362 to be used to dynamically change the viewing angles 386, 388, 390, 392 as the human eavesdropper moves within the environment, for example. Further, the directionality of the center of the viewing angles 386, 388, 390, 392 and varying widths may be adjusted to track movement of an identified, authorized user in other embodiments via execution of machine readable code instructions of the human presence CNN algorithm to prevent the authorized user from having a blurred view of the image displayed from the display panel.

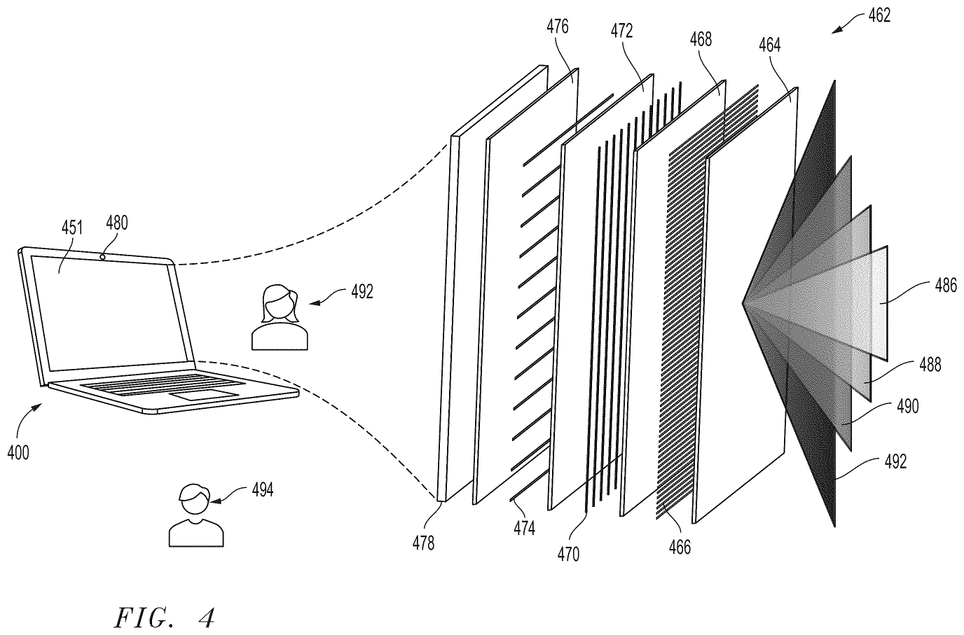

FIG. 4 is a side exploded view diagram showing a user 492 implementing an information handling system 400 that includes a MIT-based metasurface privacy layer including an adjustable MIT layer with adjustable opacity from thermoelectric heating elements and a nano-patch grating and diffraction layer to adjust a width of an image field of view according to an embodiment of the present disclosure. Again, the user 492 may not be the only person at or around the information handling system 400 and a human eavesdropper 494 may also be present that me be able to view the content presented on the digital display device of the information handling system 400.

In an embodiment, the MIT-based metasurface privacy layer 462 may include a plurality of layers that cooperate to dynamically alter the optical properties of the MIT-based metasurface privacy layer 462 and the light emitted from images displayed by the display panel 451 of the digital display device 450. These layers may be similar to those described in connection with FIG. 3 for example. As such, the MIT-based metasurface privacy layer 462 includes a nano-patch grating and diffraction layer 466 formed under the transparent cover layer 464. A first transparent layer 468 may be formed under the nano-patch grating and diffraction layer 466. As mentioned, a first thermoelectric element layer 470 may be formed below the first transparent layer 468. The first thermoelectric element layer 470 may include a plurality of thermoelectric elements that, when a voltage is applied thereto, heats the MIT layer 476 along those thermoelectric element heater lines described herein. In an embodiment, the plurality of thermoelectric elements may include a plurality of parallel lossy ITO rods arranged vertically or horizontally in columns and rows, respectively. Unlike FIG. 3, FIG. 4 shows a plurality of parallel thermoelectric elements arranged in columns in the first thermoelectric element layer 470 and in rows in the second thermoelectric element layer 474. As described herein, these plurality of rods of the first thermoelectric element layer 470 may be formed perpendicular to other plurality of rods formed within a second thermoelectric element layer 474 below the first thermoelectric element layer 470.

In an embodiment, a thermally conductive dielectric layer 472 may be formed below the first thermoelectric element layer 470. The second thermoelectric element layer 474 may be formed under the dielectric layer 472. Similar to the first thermoelectric element layer 470, the second thermoelectric element layer 474 may include a plurality of parallel thermoelectric element heater lines that, when a voltage is applied thereto, heats the MIT layer 476 in corresponding strip sections as described herein. Again, unlike FIG. 3, FIG. 4 now shows a plurality of parallel thermoelectric elements, arranged horizontally in rows in the second thermoelectric element layer 474 and perpendicular to the thermoelectric elements of the first thermoelectric element layer 470.

As described herein, the MIT layer 476 may be formed below the second thermoelectric element layer 474. In an embodiment, this transparent, MIT material may include vanadium dioxide (VO₂). The MIT material may be transparent or nearly transparent when cooled or at room temperatures. When heat is applied to a portion of the surface of the MIT layer 476 via the thermoelectric elements of the first thermoelectric element layer 470 and/or second thermoelectric element layer 474, the MIT material transitions to an opaque, metallic state along those thermoelectric element heater lines thereby preventing or interfering with some light emitted from the displayed images of the display panel 451 of the digital display device 450 passing through the MIT-based metasurface privacy layer 462 and causing diffraction at oblique angles by the nano-patch grating and diffraction layer 466 causing blur at wider angles outside the field of view for the images.

It is appreciated that light emitted from the digital display panel 451 at near-normal incidence passes directly through the layered stack with minimal distortion. However, when strip portions of the MIT layer 476 along one or more sides of the display panel 451 are activated via conversion from a transparent state to an opaque state with application of heat from the thermoelectric elements of the first thermoelectric element layer 470 and/or second thermoelectric element layer 474, light of the displayed images interacts with the nano-patch grating and diffraction layer 466 which diffracts this light in various oblique angles or blocks this light at angles outside a narrowed field of view, thereby reducing visibility from off-axis viewing angles by human eavesdroppers. The width of the narrowed field of view from either side, top or bottom, may be controlled by the number of thermoelectric elements activated from a left side, right side, bottom side, or top side in the first thermoelectric element layer 470 and/or the second thermoelectric element layer 474 in embodiments herein. As more opaque strips of MIT layer 476 are transitioned from a given side, the lower the angle of narrowness towards a center of the field of view for the viewable image and the greater set of angles having the image blurred from that given side by the MIT-based metasurface privacy layer 462 in embodiments of the present disclosure.

As described herein, a metasurface hardware microcontroller may be operatively coupled to a hardware processor of the information handling system 400. The hardware processor may interface with a human presence detection sensor that detects the presence (or lack thereof) of other humans near the digital display device and the MIT-based metasurface privacy layer 462 such as the human eavesdropper 494. This output may include identification of an angle and range of a user 492 and angles and ranges of any other detected humans such as the eavesdropper 494 to determine whether a human eavesdropper is present. Upon detection of another human besides the user 492, the output from the human presence detection sensor may be used as input to a human presence CNN algorithm for the human presence CNN algorithm to determine which and how many of the thermoelectric elements of the first thermoelectric element layer 470 and/or second thermoelectric element layer 474 are to be heated in order to switch portions of the MIT layer 476 from a transparent state to an opaque state on a side of the detected eavesdropper or on both sides in embodiments where plural eavesdropper humans are identified on both sides or generally around the user. Top and bottom thermoelectric elements may also be activated to further narrow the field of view for the displayed images in other embodiments.

When the MIT layer 476 is transitioned from the transparent state to the opaque state, one or more viewing angles 486, 488, 490, 492 of different widths may be dynamically created. For example, the activation of a certain number of thermoelectric elements of the first thermoelectric element layer 470 and/or the second thermoelectric element layer 474 may create various angles of the viewing angle in order to prevent one or more human eavesdroppers from viewing the images from the digital display panel 451 at certain angles. The creation of a specific viewing angle 486, 488, 490, 492 may be dependent on the position of the human eavesdropper as detected by the human presence detection sensor 480. The viewing angles 486, 488, 490, 492 of varying widths shown in the embodiment of FIG. 4 are shown as symmetrical as if generated by activating pairs of thermoelectric element heater lines on opposite sides, but it is understood that viewing angles 486, 488, 490, 492 of varying widths may be non-symmetrical towards one side or the other or towards the top or bottom in various embodiments of the present disclosure. This is useful for adjusting to tracking of movements for an identified, authorized user or for adjusting to location of a single eavesdropper human, such as located on one side for example. For example, where the human eavesdropper is detected at a first angle relative to the MIT-based metasurface privacy layer 462 and digital display device, a first viewing angle 486 may be created that allows only the user, directly in front of the MIT-based metasurface privacy layer 462, to see content on the digital display device. This viewing angle may change to a second viewing angle 488, a third viewing angle 490, or an n^{th} viewing angle 492 as the human eavesdropper moves further off axis from the center of the MIT-based metasurface privacy layer 462. This allows the MIT-based metasurface privacy layer 462 to be used to dynamically change the viewing angles 486, 488, 490, 492 as the human eavesdropper moves within the environment.

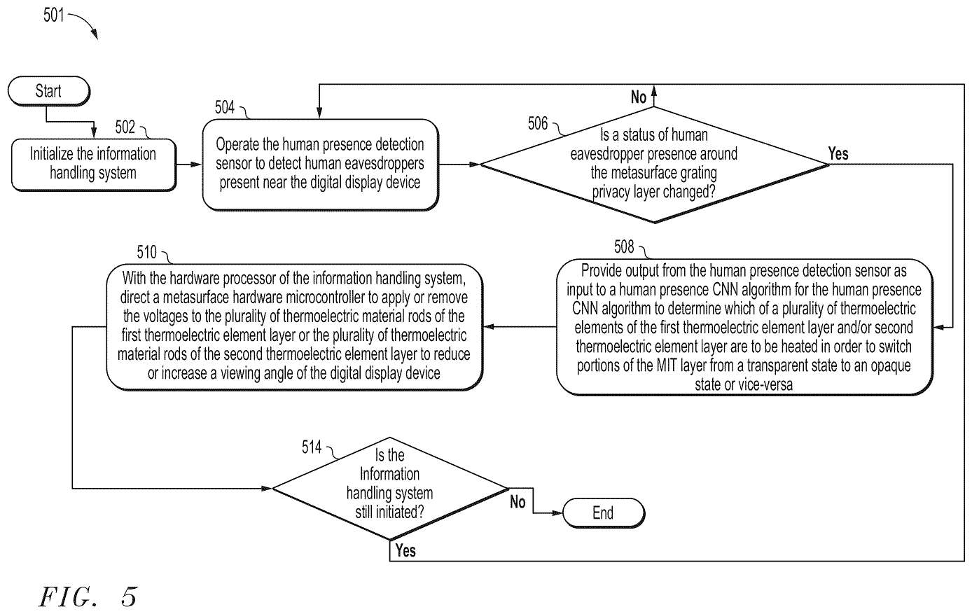

FIG. 5 is a flow diagram of a method 501 of preserving privacy at a digital display device of an information handling system using a MIT-based metasurface privacy layer that includes a metal-insulator-transition (MIT) material layer according to an embodiment of the present disclosure. The present method described in FIG. 5 may be conducted using the MIT-based metasurface privacy layer formed with the digital display device to dynamically narrow viewing angles from the digital display device as described in, for example, FIGS. 1 and 2.

At block 502, the method 501 may include initiating the information handling system. In an embodiment, the information handling system may be initiated by a user actuating a power button on the information handling system. The PMU of the information handling system may then proceed to power a hardware processor, the digital display device, the metasurface hardware controller or any metasurface microcontroller unit, the human presence sensor (e.g., LiDAR) or other components in order to prepare the MIT layer operating with the nano-patch grating and diffraction layer to be used to create privacy narrowed or expanded viewing angles for the user depending on the detection of eavesdropping persons before the digital display device.

At block 504, the method 501 may include operating the human presence detection sensor to detect human eavesdroppers present near the digital display device. The human presence detection sensor may include a LiDAR sensor arranged, such as in a bezel above the digital display device, to detect the presence (or lack thereof) of the user and other humans near the digital display device and the MIT-based metasurface privacy layer. The human presence detection sensor, such as LiDAR, operates with a hardware processor or hardware controller executing machine readable code instructions of a human presence convolutional neural network (CNN) to detect and identify the user, such as with facial or feature recognition and central location, as well as detect other humans from face or head identification at other angles in the background of the user. The human presence detection sensor, such as LiDAR, may be activated in response to detection of motion in front of the digital display device and may be used to detect viewing angles of both the identified user and eavesdropper humans detected before the digital display device.

Thus, at block 506, the hardware processor of the information handling system may receive input from the human presence detection sensor including identification of an angle and range of a user and angles and ranges of any other detected humans to determine whether a human eavesdropper is present. Where no human eavesdropper is detected, the method returns to block 504 with the human presence detection sensor continuing to monitor for such human eavesdroppers.

Where a human eavesdropper is detected at block 506, the output from the human presence detection sensor is provided to the hardware processor of the information handling system or a hardware controller of the MIT-based metasurface privacy layer for execution of machine readable code instructions of the human presence CNN algorithm at block 508. The angle and range data from the human presence detection sensor for an identified user and any present eavesdropper human presences is used as input during execution of machine readable code instructions of a trained machine learning model for the human presence CNN algorithm. Execution of machine readable code instructions for the human presence CNN algorithm automatically determines, from viewing angles and ranges of the identified user and any identified eavesdropper humans, which of a plurality of thermoelectric elements of the first thermoelectric element layer and/or second thermoelectric element layer formed in a grid over an MIT layer are to be heated in order to switch linear strip portions of the MIT layer from a transparent insulative state to an opaque metallic state, or which to cease heating if heating is already being applied.

As described herein, the MIT-based metasurface privacy layer is thin enough to be transparent in some states and may include a plurality of layers that cooperate to dynamically alter the optical properties of the MIT-based metasurface privacy layer and the light emitted from the digital display device. The MIT-based metasurface privacy layer includes a nano-patch grating and diffraction layer formed under the transparent cover layer. A first transparent layer may be formed under the nano-patch grating and diffraction layer. As mentioned, a first thermoelectric element layer may be formed below the first transparent layer and include an array of parallel heater lines as thermoelectric elements traversing an x or y dimension of a dielectric layer that is thermally conductive, such as alumina oxide (Al₂O₃). The first thermoelectric element layer may include a plurality of parallel thermoelectric elements traversing a length, such as an x-direction of a metasurface cell, and arranged in parallel heater lines across the width, such as a y-direction of the metasurface cell. The plurality of parallel thermoelectric elements may be made of lossy indium tin oxide (ITO) such that, when a voltage is applied thereto to one or more thermoelectric element heater lines, it heats corresponding linear bands or portions of the MIT layer described herein causing them to transition to a metal or opaque state.

In an embodiment, the plurality of thermoelectric elements may include a plurality of addressable lossy ITO rods arranged vertically or horizontally in columns and rows, respectively. As described herein, these plurality of ITO rods of the first thermoelectric element layer may be formed perpendicular to other second plurality of ITO rods formed as a second thermoelectric layer below or under the dielectric layer and below the first thermoelectric element layer. Thus, the second thermoelectric element layer includes second layer thermoelectric element heater lines or ITO rods traversing the dielectric in a width, such as a y-direction of the metasurface cell, perpendicular to the first layer thermoelectric element heater lines in embodiments herein. The second thermoelectric element layer may include the plurality of parallel thermoelectric elements arranged in parallel heater lines across the length, such as a y-direction, of the metasurface cell.

In an embodiment, the heat conductive dielectric layer may be formed below the first thermoelectric element layer. The second thermoelectric element layer may be formed under the heat conductive dielectric layer, or vice-versa. Similar to the first thermoelectric element layer, the second thermoelectric element layer may include the plurality of addressable thermoelectric elements (e.g., the parallel ITO rods) that, when a voltage is applied thereto, heats the MIT layer in linear bands or portions corresponding to the parallel addressable thermoelectric elements described herein. Thus, a plurality of thermoelectric elements are arranged horizontally in rows and perpendicular to the thermoelectric elements of the second thermoelectric element layer in an embodiment.

At block 510, the hardware processor may then receive the output from the execution of the human presence CNN algorithm to direct a metasurface hardware microcontroller to apply the voltages to address one or more of the plurality of thermoelectric material (e.g., lossy ITO) rods of the first thermoelectric element layer or one or more of the plurality of thermoelectric material rods of the second thermoelectric element layer to reduce a viewing angle of the digital display device. A microcontroller unit at the MIT-based metasurface privacy layer may be used to provide voltage from a voltage source to address selected thermoelectric element heater lines or rods from the first or second thermoelectric element layers based on the determination from the execution of the human presence CNN algorithm as to location of the identified user and any identification of eavesdropper human presences and which thermoelectric elements from the first or second thermoelectric element layers to activate or heat.

As described herein, the MIT layer may be formed below the second thermoelectric element layer but heated by either the first thermoelectric element layer or the second thermoelectric element layer. In an embodiment, this MIT material is thin enough to be transparent and may include vanadium dioxide (VO₂). The MIT material may be transparent or nearly transparent when at a lower temperature such as at room temperatures. When heat is applied, such as at 65 °C, to a linear band portion of the surface of the MIT layer by the thermoelectric element heater lines of the first transparent layer and/or second thermoelectric element layer, a strip of the MIT material corresponding to that thermoelectric element heater line transitions to an opaque, metallic state thereby preventing some light emitted from the digital display device from passing through the MIT-based metasurface privacy layer.

The MIT-based metasurface privacy layer includes an outer nano-patch grating and diffraction layer of densely packed metallic (e.g., aluminum or gold) nano-patches as the nano-patch grating and diffraction layer above or outward from the MIT layer in embodiments herein. The nano-patch grating and diffraction layer diffracts light from the digital display device and, when not affected by adjustments to the MIT layer, passes 95% or more of the light having little impact on the viewable image by the user. However, when one or more of the thermoelectric element heater lines of the first transparent layer and/or second thermoelectric element layer are activated with voltage to transition a corresponding linear strip of the MIT layer material to an opaque, metallic state, light from the digital display device passing linearly across this opaque linear strip in the MIT layer and at a narrow (e.g., direct) angle linearly through the nano-patch grating and diffraction layer is not diffracted or blurred by a viewer at a central viewing angle in front of the digital display screen. However, side viewing angles of the light from the digital display device that has passed through an opaque linear strip of the MIT layer material and the of the nano-patch grating and diffraction layer is diffracted to appear blurred, diminished or darkened such that content is not viewable in embodiments herein. As the one or more of the thermoelectric element heater lines of the first transparent layer and/or second thermoelectric element layer are activated towards the middle of the digital display screen from the outer sides with voltage to transition corresponding linear strips of the MIT layer material to an opaque state, the viewable window without blurring caused by diffraction of the nano-patch grating and diffraction layer is narrowed to the center viewing angle.

Further, in some embodiments, left or right sides or top or bottom portions of the one or more of the thermoelectric element heater lines of the first transparent layer and/or second thermoelectric element layer may be activated independently with voltage to transition a corresponding linear strip of the MIT layer material to an opaque, metallic state in some embodiments. The side, top, or bottom thermoelectric element heater lines may selected for heating to blur the viewing angle through the nano-patch grating and diffraction layer on that corresponding side, top, or bottom depending on a detected viewing angle location from the human presence detection sensor of an eavesdropping human presence on one or another side, above even from below the user in front of the digital display device in various embodiments herein. In yet further embodiments, viewing angles from the left, right, top or bottom sides may be controlled by selectively addressing activation of the one or more of the thermoelectric element heater lines of the first transparent layer and/or second thermoelectric element layer. This control of viewing angles is used to adjust the cone or field of viewability of displayed images in a direction of the detected and identified user in front of the digital display device such as when a user may move off-center. In embodiments herein, the human presence detection sensor, such as the LiDAR sensor, may be used to identify the user and track the location and viewing angle of the identified user in front of the digital display screen and address one or more of the thermoelectric element heater lines of the first transparent layer and/or second thermoelectric element layer based on output from the user presence CNN executing on the hardware device to dynamically adjust the restrictions on viewing angles being implemented to allow viewability toward the shifted location of the identified user.

At block 512, the method 501 includes determining if the information handling system is still initiated. Where the information handling system is still initiated, the method 501 proceeds to block 504 with the hardware processor addressing the human presence detection sensor to determine if a change to the status of human eavesdroppers still being present or additional eavesdroppers being present, including range and location angles, has been detected with respect to the digital display device with the human presence detection sensor as described herein. Then the machine readable code instructions of the user presence CNN algorithm may be executed by the hardware processor of the information handling system or hardware controller of the MIT-based metasurface privacy layer to adjust or remove restrictions on the viewing angle from the digital display device depending on status of eavesdropper human presence according to the embodiments herein. Where the information handling system is no longer initiated, the method 501 may end here.

The processes or steps and aspects of the operation of the embodiments herein and discussed herein, such as those of FIG. 5 for example, need not be performed in any given or specified order. It is contemplated that additional blocks, steps, or functions may be added, some blocks, steps or functions may not be performed, blocks, steps, or functions may occur contemporaneously, and blocks, steps, or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. An information handling system comprising:
a hardware processor, a memory device, and a power management unit (PMU) to provide power to the hardware processor and memory device;
a digital display device having a metal-insulator-transition (MIT)-based metasurface privacy layer formed in front of a digital display panel of the digital display device, wherein the MIT-based metasurface privacy layer comprises:
a first thermoelectric element layer having a first plurality of heating line thermoelectric elements in a first direction;
a second thermoelectric element layer having a second plurality of heating line thermoelectric elements in a second direction;
an MIT layer that transitions between a transparent state and an opaque state when heat is applied above a threshold temperature; and
a nano-patch grating and diffraction layer comprising a periodic array of metal nanoscale patches that is transparent but diffracts light from the display panel;
a human presence detection sensor to detect a user presence of a user and detect eavesdropper presence of human eavesdropper before the digital display device; and
the hardware processor to receive data from the human presence detection sensor and execute machine readable code instructions of a user presence machine learning algorithm to selectively address a voltage to be applied to at least a first heating line thermoelectric element of the first thermoelectric element layer or a second heating line thermoelectric element of the second thermoelectric element layer to heat the MIT layer to transition a portion of the MIT layer from the transparent state to an opaque states and blur images from light passing through the nano-patch grating and diffraction layer on a side of the display panel having the first heating line thermoelectric element or the second heating line thermoelectric element corresponding the location of the detected eavesdropper presence.

2. The information handling system of claim 1 further comprising:
the hardware processor to execute machine readable code instructions of the human presence machine learning algorithm that is a human presence convolutional neural network (CNN) algorithm to receive output from the human presence detection sensor including range and angle for a location of a detected eavesdropper presence, identify the position of human eavesdropper, and determine which of the first heating line from the first thermoelectric element layer or the second heating line from the second thermoelectric element layer on the display panel to apply voltage to activate heating an decrease a viewing angle of images from the display panel with the MIT-based metasurface privacy layer at the position of human eavesdropper.

3. The information handling system of claim 1 further comprising:
the plurality of heating line thermoelectric elements of the first thermoelectric element layer in the shape of rods of lossy indium tin oxide (ITO) arranged in the first direction that is perpendicular to the plurality of heating line thermoelectric elements of the second thermoelectric element layer as rods of lossy ITO in the second direction.

4. The information handling system of claim 1 further comprising:
the hardware processor to receive data from the human presence detection sensor and execute machine readable code instructions of the user presence machine learning algorithm to selectively address voltages to be applied to a first pair of heating line thermoelectric elements of the first thermoelectric element layer on vertically opposite sides of the display panel or a second pair of second heating line thermoelectric elements of the second thermoelectric element layer on horizontally opposite sides of the display panel to heat the MIT layer to transition opposite bands of the MIT layer from the transparent state to an opaque states and blur images from light passing through the nano-patch grating and diffraction layer on opposite sides of the display panel to narrow the field of view of images from the display panel to protect from the detected eavesdropper presence.

5. The information handling system of claim 1 further comprising:
the hardware processor to execute machine readable code instructions of the user presence machine learning algorithm to selectively address voltages to be applied to a first selection of pairs of heating line thermoelectric elements of the first thermoelectric element layer on vertically opposite sides of the display panel or a second selection of pairs of second heating line thermoelectric elements of the second thermoelectric element layer on horizontally opposite sides of the display panel to heat the MIT layer to transition corresponding sets of opposite bands of the MIT layer from the transparent state to an opaque states, wherein the number of first selection of pairs of heating line thermoelectric elements or the number of second selection of pairs of heating line thermoelectric elements selectively addressed with voltage controls a width of a field of view of images from the display panel not blurred from light passing through the nano-patch grating and diffraction layer to protect from the detected eavesdropper presence.

6. The information handling system of claim 1 further comprising:
the nano-patch grating and diffraction layer made of aluminum or gold nano-patches.

7. The information handling system of claim 1 further comprising:
a dielectric layer formed between the first thermoelectric element layer and second thermoelectric element layer that is made of thermally conductive dielectric material.

8. The information handling system of claim 1 further comprising:
the human presence detection sensor comprising a light detecting and ranging (LiDAR) sensor.

9. A method of preserving privacy at a digital display device comprising:
with a metasurface hardware controller of a metal-insulator-transition (MIT)-based metasurface privacy layer, operating a human presence detection sensor at the digital display device to detect a user and at least one human eavesdropper present near the digital display device, the digital display device including a display panel with the MIT-based metasurface privacy layer;
with the metasurface hardware controller of the MIT-based metasurface privacy layer, executing machine readable code instructions of a human presence convolutional neural network (CNN) algorithm to identify positions of human eavesdroppers around the digital display device from output of the human presence detection sensor and identify which of a first plurality of thermoelectric material rods of the first thermoelectric element layer or which of a second plurality of thermoelectric material rods of the second thermoelectric element layer to apply a voltage to activate heating at those identified thermoelectric material rods in the MIT-based metasurface privacy layer, wherein the MIT-based metasurface privacy layer includes the first thermoelectric element layer, the second thermoelectric element layer, an MIT layer to transition from a transparent state to a metallic opaque state along the thermoelectric material rods with application of the heating, and a nano-patch grating and diffraction layer comprising a periodic array of metal nanoscale patches that is transparent but diffracts light from the display panel; and
narrowing a width of a viewable field of images from the display panel and blurring images outside of the width of the viewable field of the images from the display panel from light passing through the MIT layer with at least one activated thermoelectric material rod and diffracted by the nano-patch grating and diffraction layer of the MIT-based metasurface privacy layer to protect viewing from the detected human eavesdropper.

10. The method of claim 9 further comprising:
executing machine readable code instructions of the human presence CNN algorithm to identify an authorized user of the digital display device in front of the digital display device.

11. The method of claim 9, wherein the human presence detection sensor comprises a light detecting and ranging (LiDAR) sensor.

12. The method of claim 9 further comprising:
with a metasurface hardware microcontroller, applying the voltages to the first plurality of thermoelectric material rods of the first thermoelectric element layer or the second plurality of thermoelectric material rods of the second thermoelectric element layer to narrow the width of the viewable field of the images from the display panel and blur images outside of the width of the viewable field of the images from the display panel, wherein a selected number of the first plurality of thermoelectric material rods of the first thermoelectric element layer from sides of the display panel determines a vertical width of the viewable field of the images and the selected number of the second plurality of thermoelectric material rods of the second thermoelectric element layer from a top or bottom of the display panel determines a horizontal width of the viewable field of the images.

13. The method of claim 14 further comprising:
monitoring changes in position of the authorized user, with the human presence detection sensor, in front of the digital display device to provide output to the human presence CNN algorithm to determine necessary changes to the location of the viewable field of images from the display panel and the blurring images outside of the width of the viewable field of the images from the display panel from light passing through the MIT-based metasurface privacy layer based on the changes in position of the authorized user.

14. The method of claim 9 further comprising:
monitoring changes in position of the human eavesdropper, with the human presence detection sensor, to provide output to the human presence CNN algorithm to determine necessary changes to the width of the viewable field of images from the display panel and the blurring the images outside of the width of the viewable field of the images from the display panel from light passing through the MIT-based metasurface privacy layer based on the changes in position of the human eavesdropper.

15. A metal-insulator-transition (MIT)-based metasurface privacy layer formed over an outer layer of a digital display panel of a digital display device comprising:
a metasurface hardware controller;
the MIT-based metasurface privacy layer including a first thermoelectric element layer comprising a first plurality of thermoelectric material rods, a second thermoelectric element layer comprising a second plurality of thermoelectric material rods, an MIT layer to transition from a transparent state to a metallic opaque state along the thermoelectric material rods with application of the heating, and a nano-patch grating and diffraction layer having a periodic array of metal nanoscale patches that is transparent but diffracts light from the display panel;
a human presence detection sensor at the digital display device to detect at least one human eavesdropper present in front of the digital display device;
the metasurface hardware controller executing machine readable code instructions of a human presence convolutional neural network (CNN) algorithm to identify a position of the human eavesdropper around the digital display device from output of the human presence detection sensor and identify which of a first plurality of thermoelectric material rods of the first thermoelectric element layer or which of a second plurality of thermoelectric material rods of the second thermoelectric element layer to apply a voltage to activate heating at those identified thermoelectric material rods in the MIT-based metasurface privacy layer to dynamically reduce a viewing angle at the MIT-based metasurface privacy layer of images from the digital display panel the digital display device to protect from viewing by the human eavesdropper.

16. The MIT-based metasurface privacy layer of claim 15 further comprising:
the first plurality of thermoelectric material rods of the first thermoelectric element layer and the second plurality of thermoelectric material rods of the second thermoelectric element layer being made of lossy indium tin oxide (ITO).

17. The MIT-based metasurface privacy layer of claim 15 further comprising:
the MIT layer being made of vanadium dioxide (VO₂).

18. The MIT-based metasurface privacy layer of claim 15 further comprising:
the human presence detection sensor comprising a light detecting and ranging (LiDAR) sensor.

19. The MIT-based metasurface privacy layer of claim 15 further comprising:
a metasurface hardware microcontroller applying the voltages to the first plurality of thermoelectric material rods of the first thermoelectric element layer or the second plurality of thermoelectric material rods of the second thermoelectric element layer to narrow a width of the viewing angle of a viewable field of the images from the display panel and blur images outside of the width of the viewable field of the images from the display panel, wherein a selected number of the first plurality of thermoelectric material rods of the first thermoelectric element layer from sides of the display panel determines a vertical width of the viewable field of the images and the selected number of the second plurality of thermoelectric material rods of the second thermoelectric element layer from a top or bottom of the display panel determines a horizontal width of the viewable field of the images.

20. The MIT-based metasurface privacy layer of claim 15 further comprising:
the metasurface hardware controller executing machine readable code instructions of the human presence CNN algorithm to identify an authorized user of the digital display device in front of the digital display device; and
the metasurface hardware controller monitoring changes in position of the authorized user, with the human presence detection sensor, in front of the digital display device to provide output to the human presence CNN algorithm to determine necessary changes to the location of the viewable field of the images from the display panel and the blurring the images outside of the width of the viewable field of the images from the display panel from light passing through the MIT-based metasurface privacy layer based on the changes in position of the authorized user.
